(19) United States
(12) Patent Application Publication
(10) Pub. No.: US 2017/0218232 A1
(43) Pub. Date: Aug. 3, 2017

(54) DOUBLE-FACED PRESSURE-SENSITIVE ADHESIVE SHEET AND USE THEREOF

(71) Applicant: NITTO DENKO CORPORATION, Osaka (JP)

(72) Inventors: Masahito NIWA, Osaka (JP); Masataka NISHIWAKI, Osaka (JP); Noboru YOSHIDA, Osaka (JP); Naoaki HIGUCHI, Osaka (JP); Yutaka TOSAKI, Osaka (JP); Huairui ZHU, Shanghai (CN); Junyi DING, Shanghai (CN)

(73) Assignee: NITTO DENKO CORPORATION, Osaka (JP)

(21) Appl. No.: 15/417,349

(22) Filed: Jan. 27, 2017

(30) Foreign Application Priority Data
Jan. 29, 2016 (CN) 201610065774.1

(51) Int. Cl. C09J 7/02; B32B 7/12; B32B 27/06; B32B 27/08; B32B 27/36; B32B 27/32; C09J 7/00; B32B 7/06

(52) U.S. Cl. CPC C09J 7/0246; C09J 7/00; C09J 7/0289; B32B 7/12; B32B 7/06; B32B 27/08; B32B 27/36; B32B 27/32; B32B 27/065; C09J 133/066

(57) ABSTRACT

Provided is a double-faced PSA sheet having excellent detergent resistance. The PSA sheet according to this invention comprises a PSA layer and is adhesive on both faces. The PSA sheet shows a push-peel strength of 30 N/cm² or greater after a detergent immersion test involving immersion in a standard detergent at 40° C. for 24 hours. It also has an adhesive strength retention rate of 50% or higher, determined as the ratio of push-peel strength P2 after the detergent immersion test to push-peel strength P1 before the detergent immersion test.

### CROSS-REFERENCE

This application claims priority to Chinese Patent Application No. 201610065774.1 filed on Jan. 29, 2016 and the entire content thereof is incorporated herein by reference.

### BACKGROUND OF THE INVENTION

1. Field of the Invention

The present invention relates to a double-faced pressure-sensitive adhesive sheet and use thereof.

2. Description of the Related Art

In general, pressure-sensitive adhesive (PSA) exists as a soft solid (a viscoelastic material) in a room temperature range and has a property to adhere easily to an adherend with some pressure applied. With such properties, PSA is widely used for purposes such as bonding and fastening in various fields, for instance, in forms of a substrate-supported double-faced PSA sheet having a PSA layer on each face of the substrate. Published documents disclosing this type of conventional art include Japanese Patent Application Publication No. 2015-111816 and Japanese Patent Application Publication No. 2015-155528. Both Patent Documents disclose foam substrate-supported double-faced PSA sheets. Japanese Patent Application Publication No. 2015-111816 discloses a PSA sheet used for fastening waterproof breathable membranes.

### SUMMARY OF THE INVENTION

Because portable electronics are touched by hand and carried in various environments, they are susceptible to contamination such as deposition of oil stains typified by sebum stain, dust, germs, and mud. Thus, for sanitary reasons, it is desirable to clean portable electronics every time when they get dirty or periodically. Methods for cleaning portable electronics include wiping with cleaners such as cloth and wet wipes, and washing with water. However, some of the contamination such as oil stains cannot be sufficiently removed by wiping or water washes alone. If a portable electronic device can be cleaned with various detergents such as hand soaps, for instance, the oil stains can be removed to a satisfactory degree. However, upon exposure to the detergents, etc., the PSA used for bonding, etc., in the portable electronic device may suffer a significant decrease in adhesive strength even if it is highly water resistant. Thus, cleaning (cleansing) with detergents may cause deterioration and failure in products using the PSA. It has been long desired to obtain a PSA that allows cleaning with detergents to a satisfactory degree.

The present invention has been made in view of the circumstances described above with an objective to provide a highly detergent-resistant double-faced PSA sheet. Another related objective is to provide a laminate comprising the double-faced PSA sheet.

### Solution to Problem

This invention provides an adhesively double-faced PSA sheet comprising a PSA layer. The double-faced PSA sheet exhibits a push-peel strength of 30 N/cm² or greater after a detergent immersion test involving immersion in a standard detergent at 40° C. for 24 hours. It shows an adhesive strength retention rate of 50% or higher, determined as the ratio of push-peel strength P2 after the detergent immersion test to push-peel strength P1 before the detergent immersion test.

The double-faced PSA sheet satisfying these properties has at least a certain level of adhesive strength even after cleaned with detergents. Because the change in adhesive strength is small before and after cleaning with detergents, the PSA sheet shows stable adhesive strength even after subjected to cleaning with detergents. In other words, the double-faced PSA sheet satisfying these properties has excellent resistance to detergents. An adherend to which such a double-faced PSA sheet is applied can be cleaned with detergents.

In a preferable embodiment of the double-faced PSA sheet disclosed herein, the PSA layer is an acrylic PSA layer comprising an acrylic polymer as the base polymer. When the base polymer is an acrylic polymer that can be relatively easily provided with a certain feature based on molecular designing, a feature suited to a certain intended purpose can be readily obtained in addition to the excellent detergent resistance.

In a preferable embodiment of the double-faced PSA sheet disclosed herein, the acrylic polymer is crosslinked with a crosslinking agent selected among isocyanate crosslinking agents and epoxy-based crosslinking agents. Crosslinking with an isocyanate or epoxy-based crosslinking agent can preferably bring about excellent detergent resistance. In particular, it is more preferable to use an isocyanate crosslinking agent and an epoxy-based crosslinking agent together.

In a preferable embodiment of the double-faced PSA sheet disclosed herein, the PSA layer comprises at least one species of tackifier resin selected from the group consisting of a rosin-based tackifier resin, a terpene-based tackifier resin, a phenolic tackifier resin and a petroleum resin. The use of a tackifier resin selected among these species can preferably bring about excellent detergent resistance along with high adhesive strength.

In a preferable embodiment of the double-faced PSA sheet disclosed herein, the tackifier resin content in the PSA layer is 20 parts to 45 parts by weight to 100 parts by weight of the acrylic polymer. With the use of the tackifier resin in an amount in the suitable range, excellent detergent resistance can be preferably obtained along with the adhesive properties (typically adhesive strength) obtainable with the tackifier resin.

In a preferable embodiment of the double-faced PSA sheet disclosed herein, the PSA layer has a degree of crosslinking of 30% or higher. In the embodiment where the PSA layer has at least the prescribed degree of crosslinking, excellent detergent resistance is preferably obtained.

In a preferable embodiment, the double-faced PSA sheet disclosed herein comprises a foam substrate and has the PSA layer on each face of the foam substrate. The use of the foam substrate may improve the impact absorption, contour-conformability, waterproof properties, sealing properties, etc. The double-faced PSA sheet according to another embodiment is a substrate-free double-faced PSA sheet consisting of the PSA layer. Without a substrate, such a double-faced PSA sheet can be made thinner and may contribute to downsizing of products to which the double-faced PSA sheet is applied and making them space-saving.

In a preferable embodiment of the double-faced PSA sheet disclosed herein, water invasion is not observed in an IPX7 waterproof test carried out using a polytetrafluoroethylene plate as the adherend. The double-faced PSA sheet satisfying this feature adheres well to PTFE materials to which PSA is generally poorly adhesive in addition to exhibit excellent waterproofness. Accordingly, the art disclosed herein provides a laminate comprising an adhering layer formed of a double-faced PSA sheet disclosed herein and a fluororesin layer (favorably a polytetrafluoroethylene layer) applied to an adhesive face of the adhering layer.

The double-faced PSA sheet disclosed herein is preferably used for bonding components of various portable electronics that are expected to be cleaned with detergents. Thus, the art disclosed herein provides a portable electronic device comprising a double-faced PSA sheet disclosed herein. In the portable electronic device, the double-faced PSA sheet joins components of the portable electronic device. In the portable electronic device, the double-faced PSA sheet may be placed at a location that may come in contact with water when the portable electronic device is exposed to water.

### BRIEF DESCRIPTION OF THE DRAWINGS

FIG. 1 shows a cross-sectional view schematically illustrating the constitution of the double-faced PSA sheet according to an embodiment.

FIG. 2(a) and FIG. 2(b) show schematic diagrams of a test sample used in the push-peel strength measurement, with FIG. 2(a) showing the top view and FIG. 2(b) showing the cross section along line A-A′ of FIG. 2(a).

FIG. 3 shows a diagram illustrating the method for measuring the push-peel strength.

FIG. 4(a) and FIG. 4(b) show schematic diagrams of a test sample used in the waterproof test, with FIG. 4(a) showing the top view and FIG. 4(b) showing the cross section along line B-B′ of FIG. 4(a).

### BRIEF DESCRIPTION OF THE DRAWINGS

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied. As defined in “Adhesion Fundamental and Practice” by C. A. Dahlquist (McLaren & Sons (1966), P. 143), PSA referred to herein may generally be a material that has a property satisfying complex tensile modulus E*(1Hz)<10⁷ dyne/cm² (typically, a material that exhibits the described characteristics at 25 ° C). The “base polymer” of a PSA refers to the primary component among the rubbery polymers (typically polymers that exhibit rubber elasticity in a room temperature range) in the PSA. In other words, the “base polymer” of a PSA refers to a component accounting for 50% by weight or more of the rubbery polymers.

### <Constitution of PSA Sheet>

The double-faced PSA sheet (possibly in a long form such as tape) is an adhesively double-faced PSA sheet comprising a PSA layer. It can be a substrate-supported double-faced PSA sheet or a substrate-free double-faced PSA sheet. The concept of PSA sheet herein encompasses so-called PSA tapes, PSA labels, PSA films and the like. The PSA sheet disclosed herein may be in a rolled form or in a flat sheet form. The PSA sheet may be further processed into various forms.

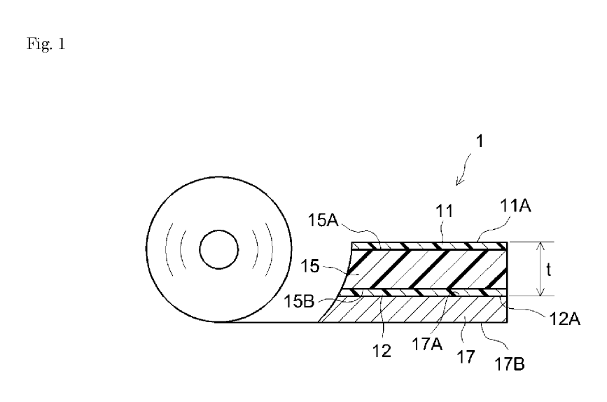

The substrate-supported double-faced PSA sheet comprises a substrate as well as first and second PSA layers provided to first and second faces of the substrate. For instance, the double-faced PSA sheet may have a cross-sectional structure as shown in FIG. 1. Double-faced PSA sheet 1 comprises a substrate 15 in a form of a sheet as well as first and second PSA layers 11 and 12 supported on the respective faces of substrate 15. More specifically, the first and second faces 15A and 15B (both non-releasable) of substrate 15 are provided with the first and second PSA layers 11 and 12, respectively. As shown in FIG. 1, prior to use (before applied to an adherend), double-faced PSA sheet 1 can be in a wound form layered with a release liner 17 having a front face 17A and a back face 17B being release faces. In double-faced PSA sheet 1 in such an embodiment, the surface (second adhesive face 12A) of the second PSA layer 12 is protected with the front face 17A of release liner 17 while the surface (first adhesive face 11A) of the first PSA layer 11 is protected with the back face 17B of release liner 17. Alternatively, it may be in an embodiment where the first and second adhesive faces 11A and 12A are protected with two separate release liners, respectively.

### <Characteristics of Double-Faced PSA Sheet>

The double-faced PSA sheet disclosed herein is characterized by having a push-peel strength (a push-peel strength after detergent immersion) of 30 N/cm² or greater after a detergent immersion test involving immersion in a standard detergent at 40° C. for 24 hours. Excellent detergent resistance may be obtained with a double-faced PSA sheet having at least the prescribed push-peel strength value after immersed in the detergent. The push-peel strength after detergent immersion is preferably 40 N/cm² or greater, more preferably 45 N/cm² or greater, yet more preferably 50 N/cm² or greater, particularly preferably 60 N/cm² or greater (e.g. 65 N/cm² or greater, or even 70 N/cm² or greater,). The push-peel strength after detergent immersion is measured by the method described later in the working examples.

The double-faced PSA sheet disclosed herein is characterized by having an adhesive strength retention rate (adhesive strength retention rate after detergent immersion) of 50% or higher, determined as the ratio of push-peel strength P2 after the detergent immersion test to push-peel strength P1 before the detergent immersion test. In the double-faced PSA sheet showing at least the prescribed adhesive strength retention rate, the change in adhesive strength is small before and after cleaning with detergents. Thus, the PSA sheet can stably maintain at least a certain level of adhesive strength even after cleaned. The adhesive strength retention rate after detergent immersion is more preferably 60% or higher, yet more preferably 70% or higher, or particularly preferably 80% or higher. The adhesive strength retention rate after detergent immersion is measured by the method described later in the working examples. The push-peel strength P1 before the detergent immersion test is the initial push-peel strength.

The double-faced PSA sheet disclosed herein preferably shows an initial push-peel strength of 30 N/cm² or greater. The double-faced PSA sheet with such high initial push-peel strength is preferable because, for instance, even when a narrow piece of the double-faced PSA sheet is adhered to an adherend, the peeling caused by internal stress is unlikely to happen and the adhesion is highly reliable. The initial push-peel strength is preferably 40 N/cm² or greater, more preferably 50 N/cm² or greater, yet more preferably 60 N/cm² or greater, particularly preferably 70 N/cm² or greater (e.g. 80 N/cm² or greater). The initial push-peel strength is measured by the method described layer in the working examples.

The double-faced PSA sheet disclosed herein shows no water invasion in an IPX7 waterproof test carried out using a polytetrafluoroethylene (PTFE) plate as the adherend. The waterproof test is measured by the method described later in the working examples.

### <PSA Layer>

### (Base Polymer)

In the art disclosed herein, the type of PSA forming the PSA layer is not particularly limited. The PSA may comprise, as the base polymer, one, two or more species selected among various polymers (adhesive polymers) such as acrylic, polyester-based, urethane-based, polyether-based, rubber-based, silicone-based, polyamide-based and fluorine-based polymers. In a preferable embodiment, the primary component of the PSA layer is an acrylic PSA. The art disclosed herein can be preferably implemented in an embodiment of the double-faced PSA sheet comprising a PSA layer essentially consisting of an acrylic PSA.

Here, the acrylic PSA refers to a PSA that comprises an acrylic polymer as the base polymer (the primary component among its polymers, i.e. a component accounting for 50% by weight or more). The acrylic polymer refers to a polymer whose primary monomer has at least one (meth)acryloyl group per molecule (or an acrylic monomer hereinafter). The primary monomer is the primary component among the monomers, that is, a component accounting for 50% by weight or more of the total amount of the monomers forming the acrylic polymer. As used herein, the term “(meth)acryloyl” comprehensively refers to acryloyl and methacryloyl. Similarly, the terms “(meth)acrylate” and “(meth)acryl” comprehensively refer to acrylate and methacrylate, and acryl and methacryl, respectively.

A preferable example of the acrylic polymer is a polymer of starting monomer(s) comprising an alkyl (meth)acrylate as the primary monomer and possibly further comprising a secondary monomer copolymerizable with the primary monomer. The primary monomer here refers to a component that accounts for more than 50% by weight of the monomer composition of the starting monomer(s).

As the alkyl (meth)acrylate, for instance, a compound represented by the following general formula (1) can be used:

CH₂═C(R¹)COOR² (1)

Herein, R¹ in the formula (1) is a hydrogen atom or a methyl group. R² is an acyclic alkyl group having 1 to 20 carbon atoms. Hereinafter, such a range of the number of carbon atoms may be indicated as C₁₋₂₀. From the standpoint of the storage elastic modulus of the PSA, etc., the primary monomer is suitably an alkyl (meth)acrylate having an acyclic C₁₋₁₄ (e.g. C₂₋₁₀, typically C₄₋₈) alkyl group for R². From the standpoint of the adhesive properties, the primary monomer is preferably an alkyl acrylate having a hydrogen atom for R¹ and an acyclic C₄₋₈ alkyl group for R². Such an alkyl acrylate may be referred simply as a C₄₋₈ alkyl acrylate hereinafter.

Examples of the alkyl (meth)acrylate having a C₁₋₂₀ acyclic alkyl group for R² include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species. Preferable alkyl (meth)acrylates include n-butyl acrylate (BA) and 2-ethylhexyl acrylate (2EHA).

The alkyl (meth)acrylate content in the total monomer content used in synthesizing the acrylic polymer is preferably 70% by weight or greater, more preferably 85% by weight or greater, or yet more preferably 90% by weight or greater. The upper limit of alkyl (meth)acrylate content is not particularly limited. It is usually preferably 99.5% by weight or less (e.g. 99% by weight or less). Alternatively, the acrylic polymer may be essentially formed of just an alkyl (meth)acrylate. When a C₄₋₈ alkyl acrylate is used as a monomer, the C₄₋₈ alkyl acrylate content is preferably 70% by weight or more, more preferably 90% by weight or more, or yet more preferably 95% by weight or more (typically 99 to 100% by weight) of the alkyl (meth)acrylate content in the monomers. The art disclosed herein can be preferably implemented in an embodiment where BA accounts for 50% by weight or more (e.g. 60% by weight or more, typically 70% by weight or more) of the total monomer content. In a preferable embodiment, the total monomer content may further comprise 2EHA at a ratio lower than BA.

In the acrylic polymer in the art disclosed herein, other monomers may be copolymerized besides those described above as long as the effects of this invention are not significantly impaired. The other monomers can be used for purposes such as adjusting the glass transition temperature (Tg) of the acrylic polymer and adjusting the adhesive properties (e.g., removability). Examples of a monomer capable of increasing the cohesive strength and heat resistance of PSA include sulfonate group-containing monomers, phosphate group-containing monomers, cyano group-containing monomers, vinyl esters, and aromatic vinyl compounds. Favorable examples among these include vinyl esters. Specific examples of vinyl esters include vinyl acetate (VAc), vinyl propionate and vinyl laurate. VAc is particularly preferable.

The other monomers capable of introducing a functional group as a possible crosslinking site into the acrylic polymer or of contributing to an increase in adhesive strength include hydroxy (OH) group-containing monomers, carboxy group-containing monomers, acid anhydride group-containing monomers, amide group-containing monomers, amino group-containing monomers, imide group-containing monomers, epoxy group-containing monomers, (meth)acryloylmorpholine, and vinyl ethers.

In a favorable acrylic polymer in the art disclosed herein, a carboxy group-containing monomer is copolymerized as the other monomer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. AA and MAA are particularly preferable.

Other favorable examples include an acrylic polymer in which a hydroxy group-containing monomer is copolymerized as the other monomer. Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono(meth)acrylate; and N-hydroxyethyl(meth)acrylamide. Particularly preferable hydroxy group-containing monomers include a hydroxyalkyl (meth)acrylate having a linear alkyl group with 2 to 4 carbon atoms.

Examples of amide group-containing monomers include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropyl methacrylamide, and diacetone acrylamide.

Examples of amino group-containing monomers include aminoethyl (meth)acrylate, N,N-dimethylaminoethyl (meth)acrylate and N,N-dimethylaminopropyl (meth)acrylate.

Examples of imide group-containing monomers include cyclohexylmaleimide, isopropylmaleimide, N-cyclohexylmaleimide, and itaconimide

Examples of epoxy group-containing monomers include glycidyl (meth)acrylate, methylglycidyl (meth)acrylate, and allyl glycidyl ether.

For the other monomer(s), solely one species or a combination of two or more species can be used. The other monomer content in total is preferably about 40% by weight or less (e.g. 30% by weight or less, typically 10% by weight or less) of the total monomer content; it is preferably 0.001% by weight or more (e.g. 0.01% by weight or more, typically 0.1% by weight or more).

When a carboxy group-containing monomer is used as the other monomer, its amount is suitably about 0.1% by weight or more (e.g. 0.5% by weight or more, typically 1% by weight or more) of the total monomer content; it is suitably 10% by weight or less (e.g. 8% by weight or less, typically 5% by weight or less). When a hydroxy group-containing monomer is used as the other monomer, its amount is suitably about 0.001% by weight or more (e.g. 0.01% by weight or more, typically 0.02% by weight or more) of the total monomer content; it is suitably 10% by weight or less (e.g. 5% by weight or less, typically 1% by weight or less). When a vinyl ester (e.g. vinyl acetate) is used as the other monomer, its amount can be, for instance, 0.1% by weight or more (usually 0.5% by weight or more) of the total monomer content; it is suitably 20% by weight or less (usually 10% by weight or less).

As the other monomer, the PSA composition may comprise a polyfunctional monomer (crosslinking monomer) for the purpose of crosslinking, etc. Examples of the polyfunctional monomer include a monomer having two or more (typically three or more) polymerizable functional groups (typically (meth)acryloyl groups) per molecule, such as 1,6-hexanediol di(meth)acrylate, ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, trimethylolpropane tri(meth)acrylate, ethylene oxide-modified trimethylolpropane tri(meth)acrylate, pentaerythritol tri(meth)acrylate, dipentaerythritol penta(meth)acrylate, and dipentaerythritol hexa(meth)acrylate. These can be used singly as one species or in a combination of two or more species.

When the PSA composition disclosed herein comprises a polyfunctional monomer (crosslinking monomer), its amount is preferably 0.01 part by weight or more (e.g. 0.02 part by weight or more, typically 0.05 part by weight or more) to 100 parts by weight of the total monomer content forming the base polymer (typically an acrylic polymer); it is preferably 1 part by weight or less (e.g. 0.5 part by weight or less).

The copolymer composition of the acrylic polymer is suitably designed so that the acrylic polymer has a glass transition temperature (Tg) of suitably −15° C. or below (typically −70° C. or above, and −15° C. or below). The acrylic polymer's Tg is preferably −25° C. or below (typically −60° C. or above, and −25° C. or below), or more preferably −40° C. or below (e.g. −60° C. or above, and −40° C. or below). From the standpoint of improving the adhesive strength of the PSA sheet, etc., it is preferable that the acrylic polymer's Tg is at or below the upper limit

The Tg of the acrylic polymer can be adjusted by suitably changing the monomer composition (i.e. types and relative amounts of monomers used for the synthesis of the polymer). Herein, the acrylic polymer's Tg (the Tg of the acrylic polymer) refers to the Tg value determined by the Fox equation based on the composition of the monomers used in the synthesis of the polymer. As shown below, the Fox equation is a relational expression of the Tg of a copolymer and the glass transition temperatures Tgi of the homopolymers obtained by hemopolymerization of the monomers constituting the copolymer.

1/Tg=Σ(Wi/Tgi)

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of the homopolymer of the monomer i.

As for the glass transition temperatures of homopolymers used in determining the Tg, the values in known documents are used. For instance, with respect to the monomers listed below, as the glass transition temperatures of their corresponding homopolymers, the following values are used:

2-ethylhexyl acrylate −70° C.

n-butyl acrylate −55° C.

2-hydroxyethyl acrylate −15° C.

4-hydroxybutyl acrylate −40° C.

vinyl acetate 32° C.

acrylic acid 106° C.

methacrylic acid 228° C.

N-vinyl-2-pyrrolidone 54° C.

With respect to the Tg values of other homopolymers besides those exemplified above, the values given in “Polymer Handbook” (3rd edition, John Wiley & Sons, Inc., Year 1989) are used. When the literature provides two or more values for a certain monomer, the highest value is used.

When no values are given in the reference book, the values obtained by the following measurement method are used.

In particular, to a reaction vessel equipped with a thermometer, a stirrer, a nitrogen inlet and a condenser, are added 100 parts by weight of monomer(s), 0.2 part by weight of 2,2′-azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature and a homopolymer solution having 33% by weight solid content is obtained. Then, this homopolymer solution is applied onto a release liner by flow coating and allowed to dry to prepare a test sample (a homopolymer sheet) of about 2 mm thickness. This test sample is cut out into a disc of 7.9 mm diameter and is placed between parallel plates. While applying a shear strain at a frequency of 1 Hz using a rheometer (trade name “ARES” available from TA Instruments Japan Inc.), the viscoelasticity is measured in the shear mode over a temperature range of −70° C. to 150° C. at a heating rate of 5° C./min. The temperature at the peak of shear loss modulus G″ (temperature at which the G″ curve maximizes) is used as the Tg of the homopolymer.

The method for obtaining the acrylic polymer is not particularly limited. Various polymerization methods known as synthetic means for acrylic polymers can be suitably employed, with the methods including a solution polymerization method, emulsion polymerization method, bulk polymerization method, suspension polymerization method, photopolymerization method, etc. For instance, a solution polymerization method can be preferably used. As a method for supplying monomers when carrying out solution polymerization, can be suitably employed an all-at-once supply method to supply all starting monomers at once, continuous (dropwise) supply method, portionwise (dropwise) supply method, etc. The polymerization temperature can be suitably selected depending on the types of monomers and solvent being used, type of polymerization initiator, etc. For example, it can be about 20° C. or higher (typically 40° C. or higher). For example, it can be about 170° C. or lower (typically 140° C. or lower). In a preferable embodiment, the polymerization temperature can be about 75° C. or lower (more preferably about 65° C. or lower, e.g. about 45° C. to 65° C).

The solvent (polymerization solvent) used for solution polymerization can be suitably selected among heretofore known organic solvents. For instance, one species of solvent or a mixture of two or more species of solvent can be used, selected from aromatic compounds (typically aromatic hydrocarbons) such as toluene; acetic acid esters such as ethyl acetate; aliphatic or alicyclic hydrocarbons such as cyclohexane; halogenated alkanes such as 1,2-dichloroethane; lower alcohols (e.g. monohydric alcohols with one to four carbon atoms) such as isopropanol; ethers such as tert-butyl methyl ether; and ketones such as methyl ethyl ketone.

The initiator used for the polymerization can be suitably selected from heretofore known polymerization initiators in accordance with the type of polymerization method. For instance, as the initiator for thermal polymerization (thermal polymerization initiator), one, two or more species of azo-based polymerization initiator, such as 2,2′-azobisisobutylonitrile (AIBN) can be preferably used. Other examples of thermal polymerization initiator include persulfate salts such as potassium persulfate, etc.; peroxide-based initiators such as benzoyl peroxide, hydrogen peroxide, etc.; substituted ethane-based initiators such as phenyl-substituted ethane, etc.; aromatic carbonyl compounds; and so on. Yet other examples of thermal polymerization initiator include a redox-based initiator by a combination of a peroxide and a reducing agent. These thermal polymerization initiators can be used singly as one species or in a combination of two or more species.

In polymerization under active energy ray irradiation (typically photopolymerization), various photopolymerization initiators can be used. The photopolymerization initiator is not particularly limited. Examples include ketal-based photopolymerization initiators such as 2,2-dimethoxy-1,2-diphenylethane-1-one; acetophenone -based photopolymerization initiators such as 1-hydroxycyclohexyl phenyl ketone, 1-[4-(2-hydroxyethoxy)-phenyl]-2-hydroxy-2-methyl-1-propane-1-one, and 2-hydroxy-2-methyl-1-phenyl-propane -1-one; benzoin ether-based photopolymerization initiators such as benzoin ethers including benzoin methyl ether and substituted benzoin ethers such as anisole methyl ether; acylphosphine oxide-based photopolymerization initiators such as bis(2,4,6-trimethylbenzoyl)phenylphosphine oxide and 2,4,6-trimethylbenzoyldiphenylphosphine oxide; α-ketol-based photopolymerization initiator include 2-methyl-2-hydroxypropiophenone, 1-[4-(2-hydroxyethy)phenyl]-2-methylpropane-1-one; aromatic sulfonyl chloride-based photopolymerization initiators such as 2-naphthalenesulfonyl chloride; photoactive oxime-based photopolymerization initiators such as 1-phenyl-1,1-propanedione-2-(o-ethoxycarbonyl)-oxime; benzoin-based photopolymerization initiators such as benzoin; benzil-based photopolymerization initiators such as benzil; benzophenone-based photopolymerization initiators such as benzophenone and benzoylbenzoic acid; thioxanthone-based photopolymerization initiators such as thioxanthone and 2-chlorothioxanthone.

Such a thermal polymerization initiator or photopolymerization initiator can be used in an amount suited to the polymerization method, polymerization mode, etc., without particular limitations. For instance, to 100 parts by weight of the monomers forming the base polymer (typically an acrylic polymer), the amount of the initiator can be 0.001 part by weight or more (typically 0.005 part by weight or more, e.g. 0.01 part by weight or more); it can be 5 parts by weight or less (typically 2 parts by weight or less, e.g. 1 part by weight or less).

The solution polymerization yields a polymerization reaction mixture in a form such that an acrylic polymer is dissolved in an organic solvent. The PSA layer in the art disclosed herein may be formed from a PSA composition comprising the polymerization reaction mixture or an acrylic polymer solution obtained by subjecting the reaction mixture to a suitable work-up. For the acrylic polymer solution, the polymerization reaction mixture can be used after adjusted to suitable viscosity (concentration) as necessary. Alternatively, an acrylic polymer can be synthesized by a polymerization method (e.g. emulsion polymerization, photopolymerization, bulk polymerization, etc.) other than solution polymerization and an acrylic polymer solution prepared by dissolving the acrylic polymer in an organic solvent can be used as well.

In the art disclosed herein, the weight average molecular weight (Mw) of the base polymer (favorably an acrylic polymer) is not particularly limited. For instance, it can be in a range of 10×10⁴ to 500×10⁴. From the standpoint of the adhesive performance, the base polymer has a Mw in a range of preferably 10×10⁴ or higher (e.g. 20×10⁴ or higher, e.g. 35×10⁴ or higher) and preferably 150×10⁴ or lower (e.g. 75×10⁴ or lower, typically to 65×10⁴ or lower). The Mw herein refers to the value in terms of standard polystyrene determined by GPC (gel permeation chromatography). As the GPC system, for instance, a model name HLC-8320GPC (column: TSKgel GMH-H(S) available from Tosoh Corporation) can be used.

In another preferable embodiment, a rubber-based PSA is used as the PSA (which can be thought as the non-volatiles of the PSA composition) forming the PSA layer disclosed herein. The rubber-based PSA refers to a PSA comprising a rubber-based polymer as the base polymer. Examples of the rubber-based polymer include natural rubber, styrene-butadiene rubber (SBR), acrylonitrile-butadiene rubber (NBR), isoprene rubber, chloroprene rubber, polyisobutylene, butyl rubber, and reclaimed rubber. These can be used singly as one species or in a combination of two or more species.

The PSA in the art disclosed herein is preferably a rubber-based PSA comprising, as the base polymer, a block copolymer of a monovinyl-substituted aromatic compound and a conjugated diene compound. The monovinyl-substituted aromatic compound refers to a compound in which a functional group containing a vinyl group is bonded to an aromatic ring. Typical examples of the aromatic ring include a benzene ring (which can be a benzene ring substituted with a functional group (e.g., an alkyl group) containing no vinyl groups). Examples of the monovinyl-substituted aromatic compound include styrene, α-methyl styrene, vinyl toluene, vinyl xylene, and the like. Examples of the conjugated diene compound include 1,3-butadiene, isoprene, and the like. These block copolymers can be used solely as one species or in a combination of two or more species.

As used herein, “block copolymer of a monovinyl-substituted aromatic compound and a conjugated diene compound” refers to a polymer comprising at least one each of a segment A that comprises a monovinyl-substituted aromatic compound as a primary monomer and a segment B that comprises a conjugated diene compound as a primary monomer, with the primary monomer being a copolymer component accounting for more than 50% by weight (the same applies hereinafter). In general, the glass transition temperature of segment A is higher than that of segment B. Typical structures of the polymer include an A-B-A triblock copolymer having a segment A (hard segment) at each terminus of a segment B (soft segment) and an A-B diblock copolymer formed of one segment A and one segment B, and the like.

Segment A (hard segment) in the block copolymer comprises the monovinyl-substituted aromatic compound (for which, two or more species can be used together) at a copolymerization ratio of preferably 70% by weight or higher (more preferably 90% by weight or higher, or even essentially 100% by weight). Segment B (soft segment) in the block copolymer comprises the conjugated diene compound (for which, two or more species can be used together) at a copolymerization ratio of preferably 70% by weight or higher (more preferably 90% by weight or higher, or even essentially 100% by weight). Such a block copolymer may bring about PSA products of higher performance.

The block copolymer may be a diblock copolymer, a triblock copolymer, a radial copolymer, a mixture of these, or the like. In a triblock copolymer or a radial copolymer, it is preferable that segment A (e.g., a styrene block) is placed at a terminal of the polymer chain. Segment A placed terminally on the polymer chain is likely to aggregate to form a domain, whereby pseudo crosslinks are formed, resulting in increased cohesion of the PSA.

In the art disclosed herein, from the standpoint of the adhesive strength (peel strength) to adherends, a preferable block copolymer has a diblock fraction of 30% by weight or higher (more preferably 40% by weight or higher, yet more preferably 50% by weight or higher, particularly preferably 60% by weight or higher, typically 65% by weight or higher). From the standpoint of the peel strength, a particularly preferable block copolymer has a diblock fraction of 70% by weight or higher. From the standpoint of the cohesion, etc., it is preferable to use a block copolymer having a diblock fraction of 90% by weight or lower (more preferably 85% by weight or lower, e.g. 80% by weight or lower). For instance, a preferable block copolymer has a diblock fraction of 60% to 85% by weight, or more preferably 70% to 85% by weight (e.g. 70% to 80% by weight).

In a preferable embodiment of the art disclosed herein, the base polymer is a styrene-based block copolymer. For instance, in a preferable embodiment, the base polymer comprises at least either a styrene-isoprene block copolymer or a styrene-butadiene block copolymer. It is preferable that the styrene-based block copolymer contained in the PSA comprises either a styrene-isoprene block copolymer at a ratio of 70% by weight or greater, a styrene-butadiene block copolymer at a ratio of 70% by weight or greater, or a styrene-isoprene block copolymer and a styrene-butadiene block copolymer at a combined ratio of 70% by weight or greater. In a preferable embodiment, essentially all (e.g., 95 to 100% by weight) of the styrene-based block copolymer is a styrene-isoprene block copolymer. In another preferable embodiment, essentially all (e.g., 95 to 100% by weight) of the styrene-based block copolymer is a styrene-butadiene block copolymer. According to such compositions, greater effects may be obtained by applying the art disclosed herein.

As used herein, “styrene-based block copolymer” refers to a polymer comprising at least one styrene block. The “styrene block” refers to a segment comprising styrene as a primary monomer. A typical example of a styrene block referred to herein is a segment consisting essentially of styrene. “Styrene-isoprene block copolymer” refers to a polymer comprising at least one styrene block and at least one isoprene block (a segment comprising isoprene as a primary monomer). Typical examples of a styrene-isoprene block copolymer include a triblock copolymer (copolymer having a triblock structure) with a styrene block (hard segment) at each terminus of an isoprene block (soft segment) and a diblock copolymer (copolymer having a diblock structure) formed of one isoprene block and one styrene block. The term “styrene-butadiene block copolymer” refers to a polymer comprising at least one styrene block and at least one butadiene block (a segment comprising butadiene as a primary monomer).

The styrene-based block copolymer can be a diblock copolymer, a triblock copolymer, a radial copolymer, a mixture of these, or the like. In a triblock copolymer and a radial copolymer, it is preferable that a styrene block is placed at a terminal of the polymer chain. The styrene block placed terminally on the polymer chain is likely to aggregate to form a styrene domain, whereby pseudo crosslinks are formed, resulting in increased cohesion of the PSA. In the art disclosed herein, from the standpoint of the adhesive strength (peel strength) to an adherend, a preferable styrene-based block copolymer has a diblock fraction of 30% by weight or greater (more preferably 40% by weight or greater, even more preferably 50% by weight or greater, or especially preferably 60% by weight or greater, typically 65% by weight or greater). The styrene-based block copolymer may have a diblock fraction of 70% by weight or greater (e.g., 75% by weight or greater). From the standpoint of the cohesive strength, etc., a preferable styrene-based block copolymer has a diblock fraction of 90% by weight or smaller (more preferably 85% by weight or smaller, e.g. 80% by weight or smaller). From the standpoint of combining several adhesive properties in a well-balanced manner by applying the art disclosed herein, the styrene-based block copolymer has a diblock fraction of preferably 60 to 85% by weight or more preferably 70 to 85% by weight (e.g. 70 to 80% by weight).

The styrene content in the styrene-based block copolymer can be, for instance, 5 to 40% by weight. From the standpoint of the cohesive strength, in usual, it is preferable that the styrene content is 10% by weight or greater (more preferably greater than 10% by weight, e.g., 12% by weight or greater). From the standpoint of the peel strength, the styrene content is preferably 35% by weight or less (typically 30% by weight or less, or more preferably 25% by weight or less) or particularly preferably 20% by weight or less (typically, less than 20% by weight, e.g. 18% by weight or less). From the standpoint of obtaining greater effects by applying the art disclosed herein, a styrene-based block copolymer having a styrene content of 12% by weight or greater, but less than 20% by weight can be preferably used.

As used herein, “the styrene content” in a styrene-based block copolymer refers to the weight fraction of styrene residue contained in the total weight of the block copolymer. The styrene content can be measured by NMR (nuclear magnetic resonance spectroscopy).

The diblock content (which hereinafter may be referred to as the “diblock fraction” or “diblock ratio”) in a styrene-based block copolymer can be determined by the following method. That is, a given styrene-based block copolymer is dissolved in tetrahydrofuran (THF) and subjected to high-performance liquid chromatography at a temperature of 40° C. with the THF as the mobile phase passing at a flow rate of 1 mL/min through four linearly connected columns consisting of two each of liquid chromatography columns GS5000H and G4000H both available from Tosoh Corporation; from the resulting chromatogram, the area of the peak corresponding to the diblock copolymer is determined; and the diblock fraction is determined as the percentage of the area of the peak corresponding to the diblock relative to the total area of all peaks.

(Tackifier resin)

The PSA composition disclosed herein comprises a tackifier resin in addition to the base polymer.

As the tackifier resin, one, two or more species (e.g. three or more species, typically four species) can be used, elected among various known tackifier resins such as rosin-based resins, terpene resins, modified terpene resins, phenolic resins, petroleum resins, styrene-based resins, coumarone-indene resins, and ketone-based resins.

The concept of rosin-based resin (rosin-based tackifier resin) herein encompasses both a rosin and a rosin-derived resin. However, a species considered as a rosin-phenol resin described later is treated as a phenolic resin instead of as a rosin-based resin.

Examples of a rosin include unmodified rosins (raw rosins) such as gum rosin, wood rosin, tall-oil rosin, etc.; modified rosins obtainable from these unmodified rosins via modifications such as hydrogenation, disproportionation, polymerization, etc. (hydrogenated rosins, disproportionated rosins, polymerized rosins, other chemically-modified rosins, etc.); and the like.

The rosin-derived resin is typically a derivative of a rosin as those listed above. The concept of rosin-based resin herein encompasses a derivative of an unmodified rosin and a derivative of a modified rosin (including a hydrogenated rosin, a disproportionated rosin, and a polymerized rosin).

Examples of a rosin-derived resin include rosin esters such as an unmodified rosin ester which is an ester of an unmodified rosin and an alcohol, and a modified rosin ester which is an ester of a modified rosin and an alcohol; an unsaturated fatty acid-modified rosin obtainable by modifying a rosin with an unsaturated fatty acid; an unsaturated fatty acid-modified rosin ester obtainable by modifying a rosin ester with an unsaturated fatty acid; rosin alcohols obtainable by reduction of carboxyl groups in rosins or aforementioned various rosin derivatives (including rosin esters, unsaturated fatty acid-modified rosin, and an unsaturated fatty acid-modified rosin ester); and metal salts of rosins or aforementioned various rosin derivatives.

Specific examples of a rosin ester include, but not limited to, a methyl ester, triethylene glycol ester, glycerin ester or pentaerythritol ester, etc., of an unmodified rosin or a modified rosin (hydrogenated rosin, disproportionated rosin, polymerized rosin, etc.).

Examples of a terpene resin (terpene -based tackifier resin) include terpenes (typically monoterpenes) such as α-pinene, β-pinene, d-limonene, 1-limonene, dipentene, etc. It can be a homopolymer of one species of terpene or a copolymer of two or more species of terpene. Examples of a homopolymer of one species of terpene include α-pinene polymer, β-pinene polymer, dipentene polymer, etc.

Examples of a modified terpene resin include resins obtainable by modifying the terpene resins. Specific examples include styrene-modified terpene resins, hydrogenated terpene resins, etc. However, a species considered as a terpene-phenol resin or a hydrogenated terpene-phenol resin is treated as a phenolic resin instead of as a modified terpene resin.

Examples of the phenolic resin (phenolic tackifier resin) referred to herein include a terpene-phenol resin, a hydrogenated terpene-phenol resin, an alkylphenol resin and a rosin-phenol resin.

The terpene-phenol resin refers to a polymer comprising a terpene residue and a phenol residue, and its concept encompasses a copolymer of a terpene and a phenol compound (terpene-phenol copolymer resin) as well as a terpene homopolymer or copolymer modified with a phenol (phenol-modified terpene resin). Preferable examples of a terpene forming such a terpene-phenol resin include the monoterpenes listed earlier. The hydrogenated terpene-phenol resin refers to a hydrogenated terpene-phenol resin having a structure of such a terpene-phenol resin with added hydrogen atoms. It is sometimes called a hydrogenated terpene-phenol resin.

The alkylphenol resin is a resin (oil-based phenol resin) obtainable from an alkylphenol and formaldehyde. Examples of the alkylphenol resin include a novolac type and a resol type.

The rosin-phenol resin is typically a resin obtainable by phenol modification of a rosin or one of the various rosin derivatives listed above (including a rosin ester, an unsaturated fatty acid-modified rosin and an unsaturated fatty acid-modified rosin ester). Examples of the rosin-phenol resin include a rosin-phenol resin obtainable by acid catalyzed addition of a phenol to a rosin or one of the various rosin derivatives listed above, followed by thermal polymerization, etc. As the rosin-phenol resin in the art disclosed herein, for instance, a phenol-modified rosin ester (rosin ester-phenol resin) can be preferably used.

Examples of petroleum resins (petroleum-based tackifier resins) include aliphatic (C5-based) petroleum resins, aromatic (C9-based) petroleum resins, aliphatic/aromatic copolymer (C5/C9-based) petroleum resins, hydrogenated products of these (e.g. alicyclic petroleum resins obtainable by hydrogenating aromatic petroleum resins) and the like.

The PSA composition disclosed herein may typically comprise, as the tackifier resin, one, two or more species of tackifier resin T_{L} having a softening point below 105° C. The softening point of the tackifier resin T_{L} is suitably about 103° C. or lower (e.g. about 100° C. or lower) and can be about 90° C. or lower (e.g. 85° C. or lower). The softening point of the tackifier resin T_{L} is usually about 60° C. or higher (e.g. 70° C. or higher, or even 75° C. or higher).

The tackifier resin T_{L} preferably comprises a rosin-based resin (favorably a rosin ester). Rosin-based resins that can be preferably used include, but are not particularly limited to, rosin esters such as unmodified rosin esters, modified rosin esters, and the like. Preferable examples of modified rosin esters include hydrogenated rosin esters. For instance, rosin esters such as a methyl ester and a glycerin ester of an unmodified rosin or a modified rosin (e.g. a hydrogenated rosin) are preferable. The tackifier resin T_{L} may comprise one species of rosin-based resin alone, or two or more species of rosin-based resin together.

When the tackifier resin T_{L} comprises two or more species of rosin-based resin, the softening points of these rosin-based resins may be the same or different. For instance, an embodiment where the tackifier resin T_{L} comprises at least two species of rosin-based resin having different softening points can be preferably employed. From the standpoint of the adhesive properties, it is preferable to select the two species of rosin-based resin so that their softening points are different by 5° C. or more (more preferably 10° C. or more, e.g. 15° C. or more). It is preferable to select the two species of rosin-based resin so that the difference between their softening points is 40° C. or less (more preferably 30° C. or less, e.g. 25° C. or less).

In the PSA composition according to a preferable embodiment, the tackifier resin T_{L} comprises a hydrogenated rosin ester. A hydrogenated rosin ester having a softening point of lower than 105° C. can be used. From the standpoint of increasing the adhesive strength at room temperature, a species having a softening point of about 100° C. or lower (typically lower than 100° C., more preferably 90° C. or lower, e.g. 85° C. or lower) is preferable. The lower limit of softening point of the hydrogenated rosin ester is not particularly limited. It is usually preferably 60° C. or higher. From the standpoint of increasing the cohesive strength, it is more preferably 70° C. or higher (e.g. 75° C. or higher).

In the PSA composition according to another embodiment, the tackifier resin T_{L} comprises a non-hydrogenated rosin ester. The non-hydrogenated rosin ester herein is a concept that comprehensively encompasses the aforementioned rosin esters excluding hydrogenated rosin esters. Examples of the non-hydrogenated rosin ester include unmodified rosin esters, disproportionated rosin esters and polymerized rosin esters. As the non-hydrogenated rosin ester, a species having a softening point of lower than 105° C. (e.g. about 100° C. or lower) can be suitably selected and used. The lower limit of softening point of the non-hydrogenated rosin ester is not particularly limited. It is usually preferably 60° C. or higher, more preferably 70° C. or higher, or yet more preferably higher than 80° C. (e.g. 90° C. or higher).

The art disclosed herein can be preferably implemented in an embodiment where the tackifier resin T_{L} comprises a hydrogenated rosin ester and a non-hydrogenated rosin ester in combination. Such an embodiment can bring about greater properties. There are no particular limitations to the relation between the softening points of the hydrogenated rosin ester and non-hydrogenated rosin ester to be used. For instance, they can be selected so that the softening point of the hydrogenated rosin ester is lower by 5° C. or more (e.g. lower by 10° C. to 30° C.) than the softening point of the non-hydrogenated rosin ester.

The tackifier resin T_{L} is not particularly limited in amount used. Usually, to 100 parts by weight of the base polymer, the tackifier resin T_{L} is suitably used in an amount of 5 parts by weight or more, for instance, 10 parts by weight or more (typically 12 parts by weight or more). The amount of the tackifier resin T_{L} used to 100 parts by weight of the base polymer is suitably 45 parts by weight or less, for instance, 35 parts by weight or less (typically 20 parts by weight or less).

For instance, in an embodiment where the tackifier resin T_{L} comprises a hydrogenated rosin ester, the amount of the hydrogenated rosin ester used to 100 parts by weight of the base polymer can be, for instance, 0.5 part by weight or more; it is preferably 1 part by weight or more, or more preferably 2 parts by weight or more; it can be, for instance, 40 parts by weight or less; it is preferably 25 parts by weight or less, or more preferably 15 parts by weight or less (e.g. 10 parts by weight or less). For instance, in an embodiment where the tackifier resin T_{L} comprises a non-hydrogenated rosin ester, the amount of the non-hydrogenated rosin ester used to 100 parts by weight of the base polymer can be, for instance, 1 part by weight or more; it is preferably 5 parts by weight or more, or more preferably 8 parts by weight or more; it can be, for instance, 35 parts by weight or less; it is preferably 25 parts by weight or less, or more preferably 15 parts by weight or less.

In an embodiment where the tackifier resin T_{L} comprises a hydrogenated rosin ester and a non-hydrogenated rosin ester, their quantitative ratio is not particularly limited. For instance, the hydrogenated rosin ester content in the total amount of the hydrogenated rosin ester and non-hydrogenated rosin ester can be 2% by weight or higher, usually suitably 5% by weight or higher, or preferably 10% by weight or higher (e.g. 15% by weight or higher). The hydrogenated rosin ester content can be 95% by weight or lower, usually suitably 80% by weight or lower, or preferably 75% by weight or lower (e.g. 50% by weight or lower). When used at such a quantitative ratio, the compatibility of the tackifier resin T_{L} to the base polymer (typically an acrylic polymer) can be adjusted to a suitable level.

The tackifier resin T_{L} may comprise other tackifier resin(s) in addition to the rosin-based resin. The rosin-based resin content in the total tackifier resin T_{L} content is usually suitably greater than 50% by weight, preferably 65% by weight or greater, or more preferably 75% by weight or greater. The art disclosed herein can be preferably implemented in an embodiment where essentially all (typically 97% by weight or more, e.g. 100% by weight) of the tackifier resin T_{L} content is a rosin-based resin.

The PSA composition disclosed herein may typically comprise, as the tackifier resin, a tackifier resin T_{H} having a softening point of 105° C. or higher and 170° C. or lower. The softening points of the tackifier resin T_{H} is preferably about 110° C. or higher (e.g. about 115° C. or higher) and suitably 160° C. or lower (e.g. about 150° C. or lower). The tackifier resin T_{H} preferably comprises a rosin-based resin (favorably a rosin ester), a phenolic resin, a terpene resin, and a petroleum resin. As the rosin-based resin, terpene resin and petroleum resin, those exemplified earlier can be preferably used. Preferable examples of the phenolic resin include a terpene-phenol resin, a hydrogenated terpene-phenol resin, an alkylphenol resin and a rosin-phenol resin (e.g. rosin ester-phenol resin). The tackifier resin T_{H} may comprise solely one species among these rosin-based resins and phenolic resins, or two or more species (e.g. three species) in combination.

The tackifier resin T_{H} may comprise a rosin-based resin and/or a phenolic resin having a softening point of 105° C. or higher as described above. The softening points of the rosin-based resin and phenolic resin are preferably about 110° C. or higher (e.g. about 115° C. or higher). The softening points of the rosin-based resin and phenolic resin can be 170° C. or lower. From the standpoint of the compatibility with acrylic polymers, it is usually suitable to use a rosin-based resin and/or a phenolic resin having a softening point of 160° C. or lower (e.g. about 150° C. or lower).

The tackifier resin T_{H} may comprise other tackifier resin(s) in addition to the rosin-based resin and/or the phenolic resin. The ratio of rosin-based resin and phenolic resin to the total tackifier resin T_{H} is usually suitably higher than 50% by weight, preferably 65% by weight or greater, or more preferably 75% by weight or greater. The art disclosed herein can be preferably implemented in an embodiment where essentially all (typically 97% by weight or more, e.g. 100% by weight) of the tackifier resin T_{H} is a rosin-based resin (favorably a rosin ester), a terpene-phenol resin, a hydrogenated terpene-phenol resin, an alkylphenol resin, a rosin-phenol resin, or a combination of these. Alternatively, the art disclosed herein can be implemented in an embodiment where the PSA layer comprises, as the tackifier resin T_{H}, at least one species (e.g. a terpene phenolic resin or a rosin phenol resin) among a terpene phenolic resin, a hydrogenated terpene phenolic resin, an alkylphenol resin and a rosin phenol resin in an amount of 25 parts by weight or less, preferably 15 parts by weight or less, yet more preferably 10 parts by weight or less, or even more preferably 5 parts by weight or less to 100 parts by weight of the base polymer; or in an embodiment where the PSA layer is free of a tackifier resin T_{H}.

The amount of the tackifier resin T_{H} used is not particularly limited. Usually, it is suitably 50 parts by weight or less (typically 40 parts by weight or less, e.g. 30 parts by weight or less, or even 25 parts by weight or less) to 100 parts by weight of the base polymer. The amount of the tackifier resin T_{H} used to 100 parts by weight of the base polymer is usually suitably 5 parts by weight or greater, preferably 10 parts by weight or greater, or more preferably 15 parts by weight or greater. Alternatively, when a rubber-based polymer is used as the base polymer of the PSA, to 100 parts by weight of the base polymer, the tackifier resin T_{H} content can be 120 parts by weight or less, preferably 100 parts by weight or less, or more preferably 80 parts by weight or less (e.g. 60 parts by weight or less).

Usually, the combined amount of the tackifier resins T_{L} and T_{H} is suitably, but not particularly limited to, about 60 parts by weight or less to 100 parts by weight of the base polymer. This preferably brings about the effects of the art disclosed herein. To obtain greater effects, their combined amount is advantageously 55 parts by weight or less (typically 50 parts by weight or less, or even 45 parts by weight or less). Their combined amount is usually 10 parts by weight or greater, preferably 20 parts by weight or greater, more preferably 25 parts by weight or greater, or yet more preferably 35 parts by weight or greater.

The ratio of the tackifier resin T_{H} in the combined amount of the tackifier resins T_{L} and T_{H} is not particularly limited. From the standpoint of favorably bringing about the effects of the art disclosed herein, the ratio of the tackifier resin T_{H} is usually about 30% by weight or higher (typically higher than 50% by weight, e.g. 60% by weight or higher); it is about 80% by weight or lower (e.g. 70% by weight or lower).

The tackifier resin in the art disclosed herein may comprise other tackifier resin(s) (e.g. a tackifier resin having a softening point of higher than 170° C.) besides the tackifier resin T_{L} and tackifier resin T_{H}. The combined tackifier resin T_{L} and tackifier resin T_{H} content of the total tackifier resin content in the PSA composition is typically 75% by weight or greater, preferably 90% by weight or greater, or more preferably 95% by weight or greater. The PSA composition according to a preferable embodiment is essentially free of a tackifier resin other than the tackifier resin T_{L} and tackifier resin T_{H}.

The softening point of a tackifier resin referred to herein is defined as a value measured based on the softening point test method (ring and ball method) specified in JIS K5902 and JIS K2207. In particular, a sample is quickly melted at a lowest possible temperature, and with caution to avoid bubble formation, the melted sample is poured into a ring to the top, with the ring being placed on top of a flat metal plate. After cooled, any portion of the sample risen above the plane including the upper rim of the ring is sliced off with a small knife that has been somewhat heated. Following this, a support (ring support) is placed in a glass container (heating bath) having a diameter of 85 mm or larger and a height of 127 mm or larger, and glycerin is poured into this to a depth of 90 mm or deeper. Then, a steel ball (9.5 mm diameter, weighing 3.5 g) and the ring filled with the sample are immersed in the glycerin while preventing them from touching each other, and the temperature of glycerin is maintained at 20° C.±5° C. for 15 minutes. The steel ball is then placed at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated evenly by projecting a Bunsen burner flame at the midpoint between the center and the rim of the bottom of the container. After the temperature has reached 40° C. from the start of heating, the rate of the bath temperature rise must be kept at 5° C.±0.5° C. per minute. As the sample gradually softens, the temperature at which the sample flows out of the ring and finally touches the bottom plate is read as the softening point. Two or more measurements of softening point are performed at the same time, and their average value is used.

The amount (in total) of the tackifier resin used is not particularly limited and can be suitably selected in accordance with the desired adhesive properties (adhesive strength, etc.). For instance, to 100 parts by weight of the base polymer, the tackifier resin is used at a ratio of suitably about 10 parts by weight or higher or preferably 20 parts by weight or higher (typically 30 parts by weight or higher, e.g. 35 parts by weight or higher). To 100 parts by weight of the base polymer, the tackifier resin is used at a ratio of suitably 100 parts by weight or lower in total or preferably 60 parts by weight or lower (typically 50 parts by weight or lower, e.g. 45 parts by weight or lower). Alternatively, when a rubber-based polymer is used as the base polymer of the PSA, to 100 parts by weight of the base polymer, the tackifier resin content can be 200 parts by weight or less; it is preferably 150 parts by weight or less, or more preferably 120 parts by weight or less (e.g. 100 parts by weight or less).

### (Crosslinking Agent)

The PSA composition used for forming PSA preferably comprises a crosslinking agent. By including the crosslinking agent in the PSA composition, a crosslinked structure is incorporated in the PSA. For instance, when using an acrylic polymer as the base polymer, the acrylic polymer can be crosslinked with the crosslinking agent. The type of crosslinking agent is not particularly limited. A suitable species can be selected and used among isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, amine-based crosslinking agents, and the like. For the crosslinking agent, solely one species or a combination of two or more species can be used. In particular, isocyanate crosslinking agents and epoxy-based crosslinking agents are preferable.

As the epoxy-based crosslinking agent, a compound having at least two epoxy groups per molecule can be used without particular limitations. A preferable epoxy-based crosslinking agent has three to five epoxy groups per molecule. For the epoxy-based crosslinking agent, solely one species or a combination of two or more species can be used.

Specific examples of the epoxy-based crosslinking agent include, but are not particularly limited to, N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Commercial epoxy-based crosslinking agents include trade names TETRAD-C and TETRAD-X available from Mitsubishi Gas Chemical Co., Inc.; trade name EPICLOM CR-5L available from DIC Corporation; trade name DENACOL EX-512 available from Nagase ChemteX Corporation; and trade name TEPIC-G available from Nissan Chemical Industries, Ltd.

When an epoxy-based crosslinking agent is used, its amount is not particularly limited. For instance, it can be greater than 0 part by weight, but 3 parts by weight or less (typically 0.001 to 3 parts by weight) relative to 100 parts by weight of the base polymer (preferably an acrylic polymer). From the standpoint of favorably obtaining the effect to increase the cohesive strength, the amount of the epoxy-based crosslinking agent to 100 parts by weight of the base polymer is preferably 0.005 part by weight or greater (e.g. 0.008 part by weight or greater). From the standpoint of increasing the adhesive strength and anchoring strength to adherends and substrates, the amount of epoxy-based crosslinking agent to 100 parts by weight of the base polymer is preferably 1 part by weight or less, or more preferably 0.5 part by weight or less (typically 0.2 part by weight or less, e.g. 0.1 part by weight or less, or even 0.05 part by weight or less).

As the isocyanate-based crosslinking agent, a polyfunctional isocyanate (which refers to a compound having an average of two or more isocyanate groups per molecule, including a compound having an isocyanurate structure) can be preferably used. For the isocyanate-based crosslinking agent, solely one species or a combination of two or more species can be used.

Examples of the polyfunctional isocyanate include aliphatic polyisocyanates, alicyclic polyisocyanates, and aromatic polyisocyanates.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, and lysine diisocyanate.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

A preferable example of the polyfunctional isocyanate has an average of three or more isocyanate groups per molecule. Such a tri-functional or higher polyfunctional isocyanate can be a multimer (typically a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate. Commercial polyfunctional isocyanates include trade name DURANATE TPA-100 available from Asahi Kasei Chemicals Corporation and trade names CORONATE L, CORONATE HL, CORONATE HK, CORONATE HX, and CORONATE 2096 available from Tosoh Corporation.

When an isocyanate-based crosslinking agent is used, its amount is not particularly limited. For instance, to 100 parts by weight of the base polymer (preferably an acrylic polymer), it can be more than 0 part by weight up to 10 parts by weight or less (typically 0.01 part to 10 parts by weight). From the standpoint of preferably bringing about the effects of the art disclosed herein, the amount of the isocyanate-based crosslinking agent is preferably 0.5 part by weight or greater (e.g. 1 part by weight or greater, typically 2 parts by weight or greater) to 100 parts by weight of the base polymer. From the same standpoint, the amount of the isocyanate-based crosslinking agent is preferably 8 parts by weight or less, or more preferably 6 parts by weight or less to 100 parts by weight of the base polymer.

The total amount of the crosslinking agent used is not particularly limited. For instance, to 100 parts by weight of the base polymer (preferably an acrylic polymer), it can be selected from a range of about 0.005 part by weight or greater (e.g. 0.01 part by weight or greater, typically 0.1 part by weight or greater) to about 10 parts by weight or less (e.g. about 8 parts by weight or less, preferably about 5 parts by weight or less).

### (Other Components)

The PSA composition disclosed herein may comprise an acrylic oligomer in order to improve the adhesive properties (e.g. drop impact resistance and repulsion resistance). For instance, when a PSA composition (favorably an acrylic PSA composition) that cures with active energy rays (typically ultraviolet (UV)) is used, an acrylic oligomer is used preferably. The acrylic oligomer's Mw is not particularly limited. Typically, it is about 0.1×10⁴ to 3×10⁴. When the PSA composition disclosed herein comprises an acrylic oligomer, the acrylic oligomer content in the PSA composition is, for instance, suitably 0.5 part by weight or more to 100 parts by weight of the base polymer (typically an acrylic polymer), or preferably 1 part by weight or more (e.g. 1.5 parts by weight or more, typically 2 parts by weight or more). From the standpoint of the PSA composition's curability and compatibility with the base polymer, etc., the acrylic oligomer content is suitably less than 50 parts by weight (e.g. less than 10 parts by weight), or preferably less than 8 parts by weight (e.g. less than 7 parts by weight, typically 5 parts by weight or less).

The PSA composition may comprise, as necessary, various additives generally used in the field of PSA compositions, such as leveling agent, crosslinking co-agent, plasticizer, softening agent, filler, colorant (pigment, dye, etc.), anti-static agent, anti-aging agent, ultraviolet light absorber, anti-oxidant, and photostabilizing agent. For instance, the PSA composition may comprise a foaming agent such as hollow microspheres and thermally expandable microspheres. These additives can be preferably used as PSA components in substrate-free double-faced PSA sheets. With respect to these various additives, heretofore known species can be used by typical methods. Because they do not particularly characterize this invention, details are omitted.

The PSA layer (a layer formed of the PSA) disclosed herein may be formed from an aqueous PSA composition, solvent-based PSA composition, hot-melt PSA composition, or active energy ray-curable PSA composition. The aqueous PSA composition refers to a PSA composition comprising a PSA (PSA layer-forming components) in a solvent primarily comprising water (an aqueous solvent) and typically encompasses what is called a water-dispersed PSA composition (a composition in which the PSA is at least partially dispersed in water). The solvent-based PSA composition refers to a PSA composition comprising a PSA in an organic solvent.

From the standpoint of obtaining even greater adhesive properties, a solvent-based PSA composition is especially preferable. The solvent-based PSA composition can typically be prepared as a solution containing the respective components described above in an organic solvent. The organic solvent can be selected among known or conventional organic solvents. For instance, any one species or a mixture of two or more species can be used among aromatic compounds (typically aromatic hydrocarbons) such as toluene and xylene; acetic acid esters such as ethyl acetate and butyl acetate; aliphatic or alicyclic hydrocarbons such as hexane, cyclohexane, and methyl cyclohexane; halogenated alkanes such as 1,2-dichloroethane; and ketones such as methyl ethyl ketone, and acetyl acetone.

In another embodiment, the PSA layer is formed from a PSA composition that cures with active energy rays (typically UV rays). The PSA composition can be in an embodiment where it comprises a partial polymerization product of the monomers and unreacted monomers (typically in an embodiment where the polymerization product is dissolved in the unreacted monomers); and therefore, without dilution with a solvent or a dispersion medium, it may have viscosity suited to application at room temperature. Thus, it may be a solvent-free PSA composition (a PSA composition essentially free of a solvent). The PSA composition being essentially free of a solvent means that the solvent content of the PSA composition is 5% by weight or less (typically 2% by weight or less, preferably 1% by weight or less).

The PSA layer disclosed herein can be formed by a heretofore known method. For instance, when the double-faced PSA sheet comprises a substrate, it is possible to employ a direct method where the PSA composition is directly provided (typically applied) to the substrate and allowed to dry to form a PSA layer. Alternatively, it is possible to employ a transfer method where the PSA composition is provided to a highly releasable surface (e.g. release face) and allowed to dry to form a PSA layer on the surface. In the transfer method, for instance, the PSA layer formed on the release face is transferred to the substrate to fabricate the double-faced PSA sheet comprising the substrate. As the release face, the surface of a release liner, a release agent-treated back face of a substrate film, etc., can be used. The PSA layer disclosed herein is not limited to, but typically formed in a continuous form. For instance, the PSA layer may be formed in a regular or random pattern of dots, stripes, etc.

The PSA composition can be applied with a heretofore known coater, for instance, a gravure roll coater, die coater, and bar coater. Alternatively, the PSA composition can be applied by immersion, curtain coating, etc.

From the standpoint of facilitating the crosslinking reaction, increasing the production efficiency, etc., the PSA composition is dried preferably with heating. The drying temperature can be, for instance, about 40° C. or higher (usually 60° C. or higher) and 150° C. or lower (usually 130° C. or lower). After the PSA composition is dried, it can be aged for purposes such as adjusting migration of the components in the PSA layer, accelerating the crosslinking reaction, and releasing the distortion that may be present in the substrate film and the PSA layer.

The PSA layer is not particularly limited in thickness. Usually, the PSA layer has a thickness of suitably about 150 μm or less, preferably about 110 μm or less, more preferably about 100 μm or less, or yet more preferably about 75 μm or less (e.g. 50 μm or less, typically 35 μm or less). The minimum thickness of the PSA layer in the art disclosed herein is not particularly limited. In general, with decreasing thickness of the PSA layer, the tightness of adhesion to adherends tends to decrease. Thus, it is advantageously about 5 μm or greater, preferably about 10 μm or greater, or more preferably about 15 μm or greater (e.g. about 20 μm or greater). When the double-faced PSA sheet has the first and second PSA layers on the respective sides of the substrate, the thicknesses of the first and second PSA layers maybe the same or different. It is usually preferable to employ a constitution where the thicknesses of the two PSA layers are about the same. Each PSA layer maybe in a mono-layer form or a multi-layer form. In another embodiment, the thickness of the PSA layer is about 90 μm or greater (e.g. 140 μm or greater, typically 180 μm or greater); it is preferably about 1500 μm or less (e.g. 600 μm or less, typically 300 μm or less). The thickness can be preferably applied to the PSA layer of a substrate-free double-faced PSA sheet or more preferably to a PSA layer that cures with active energy rays (typically with UV rays).

While no particular limitations are imposed, the PSA layer may have a degree of crosslinking (a gel fraction) of, for instance, 10% or higher. From the standpoint of preferably obtaining the effects of the art disclosed herein, the degree of crosslinking is usually 15% by weight or higher, or suitably 20% by weight or higher (e.g. 25% by weigh or higher, typically 30% by weight or higher). From the same standpoint, the degree of crosslinking is usually 80% by weight or lower, or suitably 70% by weight or lower (e.g. 60% by weight or lower, typically 50% by weight or lower, or even 40% by weight or lower). The degree of crosslinking of a PSA layer can be adjusted, for instance, by the composition and molecular weight of the base polymer, the use of a crosslinking agent as well as its type and amount if any, and so on. The maximum degree of crosslinking is theoretically 100% by weight. The degree of crosslinking of the PSA layer is measured by the method described later in the working examples. In measuring the degree of crosslinking of the PSA layer, as the porous PTFE sheet, trade name NITOFLON NTF1122 available from Nitto Denko Corporation or an equivalent product can be used.

### <Substrate>

In applying the art disclosed herein to a substrate-supported double-faced PSA sheet, as the substrate (support substrate) to support (back) the PSA layer, a suitable species can be selected and used in accordance with the purpose of the PSA sheet among plastic films such as polyolefin films comprising a polyolefin as the primary component including polypropylenes and ethylene-propylene copolymers, polyester films comprising a polyester as the primary component including polyethylene terephthalate (PET) and polybutylene terephthalate, polyvinyl chloride films comprising polyvinyl chloride as the primary component; foam sheets made of foam such as polyurethane foam, polyethylene foam, and polychloroprene foam; woven fabrics and non-woven fabrics (meaning to include paper such as Washi and high-grade paper) of a single species or a blend of various species of fibrous substances (which can be natural fibers such as hemp and cotton; synthetic fibers such as polyester and vinylon; semi-synthetic fibers such as acetate); metal foil such as aluminum foil and copper foil.

The PSA layer-side surface of the substrate maybe subjected to a heretofore known surface treatment such as corona discharge treatment, plasma treatment, UV irradiation, acid treatment, base treatment, and primer coating. Such surface treatment may be provided to increase the tightness of adhesion between the substrate and the PSA layer, that is, the anchoring of the PSA layer to the substrate.

The thickness of the substrate can be suitably selected in accordance with the purpose. It is generally about 2 μm or greater (e.g. 10 μm or greater, typically 20 μm or greater) and about 1000 μm or less (e.g. 500 μm or less, typically 200 μm or less).

In a preferable embodiment, the double-faced PSA sheet comprises a foam substrate and has a PSA layer on each face of the foam substrate. In the art disclosed herein, the foam substrate sheet refers to a substrate comprising a portion having pores (a porous structure), typically referring to a substrate comprising a thin layer of foam (a foam layer) as a component. The foam substrate may essentially consist of one, two or more foam layers. While no particular limitations are imposed, a preferable foam substrate in the art disclosed herein is in a single layer (one layer).

The material of the foam substrate is not particularly limited. It is usually preferable to use a foam substrate comprising a layer formed of plastic foam (foam of a plastic material). The plastic material (meaning to encompass rubber materials) for forming the plastic foam is not particularly limited, and can be suitably selected among known plastic materials. One species of plastic material can be used solely, or two or more species can be used in combination.

Specific examples of a plastic foam include polyolefin-based resin foams such as polyethylene foams, polypropylene foams, etc.; polyester-based resin foams such as PET foams, polyethylene naphthalate foams, polybutylene terephthalate foams, etc.; polyvinyl chloride-based resin foams such as polyvinyl chloride foams, etc.; vinyl acetate-based resin foams; polyphenylene sulfide resin foams; amide-based resin foams such as polyamide (nylon) resin foams, wholly aromatic polyamide (aramid) resin foams, etc.; polyimide-based resin foams; polyether ether ketone (PEEK) resin foams; styrene-based resin foams such as polystyrene foams, etc.; urethane-based resin foams such as polyurethane resin foams, etc.; and the like. Alternatively, as the plastic foam, a rubber-based resin foam can be used, such as a polychloroprene rubber foam and urethane rubber foam.

Examples of preferable foam include polyolefin-based resin foams (or polyolefin-based foams, hereinafter). As the polyolefin-based resin foam-constituting plastic material (i.e., a polyolefin-based resin), can be used a known or conventional polyolefin-based resin of various types without any particular limitations. Examples include polyethylenes such as low density polyethylenes (LDPE), linear low density polyethylenes (LLDPE), and high density polyethylenes (HDPE); polypropylenes; ethylene-propylene copolymers; ethylene-vinyl acetate copolymers; and the like. Examples of LLDPE include Ziegler-Natta catalyst-based linear low density polyethylenes and metallocene-catalyst-based linear low density polyethylenes. Among these polyolefin-based resins, can be used one species alone, or two or more species in a suitable combination.

From the standpoint of the impact resistance, waterproofness, etc., particularly preferable examples of the foam substrate in the art disclosed herein include a polyethylene-based foam substrate consisting essentially of a polyethylene-based resin foam, a polypropylene-based foam substrate consisting essentially of a polypropylene-based resin foam, and the like. Herein, the polyethylene-based resin refers to a resin formed from ethylene as the primary monomer (i.e., the primary component among monomers), with the resin encompassing HDPE, LDPE and LLDPE as well as ethylene-propylene copolymers and ethylene-vinyl acetate copolymers each having a copolymerization ratio of ethylene exceeding 50% by weight, and the like. Similarly, the polypropylene-based resin refers to a resin formed from propylene as the primary monomer. As the foam substrate in the art disclosed herein, can be preferably used a polyethylene-based foam substrate.

The method for producing the plastic foam (typically polyolefinic foam) is not particularly limited. It can be produced by a known method. For instance, it can be produced by a method that comprises a molding step, a crosslinking step and a foaming step of the plastic foam. It may also include a stretching step as necessary.

Examples of the method for crosslinking the plastic foam include a chemical crosslinking method that uses an organic peroxide, etc.; and a crosslinking method involving ionizing radiation (ionizing radiation crosslinking) These methods can be used in combination. Examples of the ionizing radiation include electron beam, α radiation, β radiation and γ radiation. The dosage of the ionizing radiation can be suitably adjusted so as to obtain physical properties (degree of crosslinking, flexibility, etc.) required in the plastic foam.

The average pore diameter (based on equivalent spheres) of the foam substrate (e.g. a polyolefinic foam substrate) is not particularly limited. It is usually preferably 10 μm or larger, more preferably 15 μm or larger, or yet more preferably 20 μm or larger (e.g. 25 μm or larger). When the foam substrate has an average pore diameter (based on equivalent spheres) of 10 μm or larger, the impact resistance tends to increase. The average pore diameter is preferably 500 μm or less, more preferably 300 μm or less, or yet more preferably 200 μm or less (e.g. 100 μm or less). When the foam substrate has an average pore diameter (based on equivalent spheres) of 500 μm or less, the waterproof properties tend to increase.

In this description, the average pore diameter (based on equivalent spheres) refers to the value measured in the following procedures: after an arbitrary cross section of the foam substrate is analyzed by scanning electron microscopy (SEM), its image is processed into a binary format by image processing software to separate pores from the rest (e.g. plastic resin portions) and the surface areas of the pores are individually determined; subsequently, the surface areas of the pores are converted to equivalent circular areas and their individual diameters are averaged; and the average value is used as the average pore diameter (based on equivalent spheres) of the foam substrate. As for the SEM system, model S-4800 available from Hitachi High-Technologies Corporation or an equivalent system can be used. As the image processing software, trade name IMAGE J available from the U.S. National Institutes of Health or an equivalent product can be used.

The average pore diameter (based on equivalent spheres) of the foam substrate is suitably 50% or less of the thickness of the foam substrate or preferably 30% or less (e.g. 10% or less). When the average pore diameter (based on equivalent spheres) of the foam substrate is 50% or less of the thickness of the foam substrate, the waterproof properties tend to further increase.

As used herein, the machine direction (MD) of the foam substrate refers to the direction of extrusion in the manufacturing process of the foam substrate. While no particular limitations are imposed, when the foam substrate is long as in a tape form, the MD of the foam substrate usually coincides with the length direction. The cross-machine direction (CD) of the foam substrate refers to the direction that is vertical to the MD and in the plane of the surface of the foam substrate. The thickness direction (vertical direction, VD) of the foam substrate refers to a direction vertical to the surface of the foam substrate, that is, a direction vertical to both the MD and the CD.

The density (apparent density) of the foam substrate is preferably, but not particularly limited to, for instance, 0.2 g/cm³ or greater. The density of the foam substrate is more preferably 0.25 g/cm³ or greater, or more preferably greater than 0.3 g/cm³ (e.g. 0.35 g/cm³ or greater). With the density being 0.2 g/cm³ or greater, it tends to bring about an increase in strength of the foam substrate (and even in strength of the double-faced PSA sheet) as well as increases in impact resistance and handling properties. The density (apparent density) of the foam substrate is preferably, for instance, 0.6 g/cm³ or less. The density of the foam substrate is more preferably 0.55 g/cm³ or less, or yet more preferably 0.5 g/cm³ or less. With the density being 0.6 g/cm³ or less, it tends to increase the contour conformability, repulsion resistance and waterproof properties. The density (apparent density) of a foam substrate can be measured, for instance, by a method based on JIS K 6767. In this description, the density (g/cm³) of a foam substrate is the reciprocal of the expansion ratio (fold increase).

The foam substrate (e.g. a polyolefinic foam substrate) is not particularly limited in tensile strength. For instance, the MD tensile strength is preferably 1 MPa or greater (more preferably 2 MPa or greater, yet more preferably 2.5 MPa or greater, typically 3 MPa or greater); it is preferably 30 MPa or less (more preferably 20 MPa or less, yet more preferably 10 MPa or less, typically 7 MPa or less). The CD tensile strength is preferably 1 MPa or greater (more preferably 3 MPa or greater, yet more preferably 4 MPa or greater, typically 4.5 MPa or greater); it is preferably 30 MPa or less (more preferably 20 MPa or less, yet more preferably 15 MPa or less, typically 10 MPa or less). When the tensile strength is at or above the lower limit values given above, for instance, when the double-faced PSA sheet is removed to recover some parts, the PSA sheet may exhibit excellent handling properties (re-workability) such as easy removal without tearing of the substrate (and also the double-faced PSA sheet). On the other hand, when the tensile strength is at or below the upper limit values given above, the impact resistance and the contour conformability may increase. The tensile strength (MD and CD tensile strength) of a foam substrate can be measured based on JIS K 6767. The tensile strength of the foam substrate can be controlled, for instance, by the degree of crosslinking, density, etc.

The foam substrate (e.g. a polyolefinic foam substrate) is not particularly limited in 25% compressive strength (compressive hardness). For instance, it is preferably 50 kPa or greater. The 25% compressive strength of the foam substrate is more preferably greater than 60 kPa. The 25% compressive strength is preferably, for instance, 1000 kPa or less. The 25% compressive strength of the foam substrate is more preferably 500 kPa or less, or yet more preferably 300 kPa or less (typically 200 kPa or less, e.g. 150 kPa or less). Here, the 25% compressive strength of the foam substrate refers to the load required to compress the foam substrate (layered to about 25 mm in thickness and placed between flat plates) by a thickness equivalent to 25% of the initial thickness, that is, the load required to compress the substrate to a thickness equivalent to 75% of the initial thickness. When the 25% compressive strength is 50 kPa or greater, the impact resistance of the double-faced PSA sheet tends to increase and the size stability for processing may increase as well. On the other hand, when the 25% compressive strength is 1000 kPa or less, the repulsion resistance and the contour conformability may increase. The 25% compressive strength of a foam substrate is measured based on JIS K 6767. The 25% compressive strength of the foam substrate can be controlled, for instance, by the degree of crosslinking, density, etc.

The foam substrate is not particularly limited in tensile elongation (percent elongation). For instance, a foam substrate having an MD tensile elongation of 200% or greater (more preferably 400% or greater) can be favorably used. The MD tensile elongation is preferably 800% or less, or more preferably 600% or less. Apreferable foam substrate has a CD tensile elongation of 50% or greater (more preferably 100% or greater). The CD tensile elongation is preferably 800% or less, or more preferably 300% or less. The tensile elongation of a foam substrate is measured based on JIS K 6767. Elongation of the foam substrate can be controlled, for instance, by the degree of crosslinking, apparent density (expansion ratio), etc.

The foam substrate may comprise various additives as necessary such as fillers (inorganic fillers, organic fillers, etc.), anti-aging agent, antioxidant, UV absorber, anti-static agent, slipping agent, plasticizers, flame retardant, and surfactant.

The foam substrate in the art disclosed herein may be colored in order to bring about desirable design or optical properties (e.g., light-blocking ability, light-reflecting ability, etc.) in the double-faced PSA sheet. For coloring the foam substrate, among known organic or inorganic colorants, solely one species or a combination of two or more species can be used.

For example, when the double-faced PSA sheet disclosed herein is used for a light blocking purpose, although not particularly limited, the foam substrate has a visible light transmittance of preferably 0% or higher and 15% or lower, or more preferably 0% or higher and 10% or lower, similarly to the visible light transmittance of the double-faced PSA sheet described later. When the double-faced PSA sheet disclosed herein is used for a light reflecting purpose, the foam substrate has a visible light reflectivity of preferably 20% or higher and 100% or lower, or more preferably 25% or higher and 100% or lower, similarly to the visible light reflectivity of the double-faced PSA sheet.

The visible light transmittance of a foam substrate can be determined by irradiating one face of the foam substrate with 550 nm wavelength light using a spectrophotometer (e.g., a spectrophotometer under model number U-4100 available from Hitachi High-Technologies Corporation) and measuring the intensity of the light transmitted to the other side of the foam substrate. The visible light reflectivity of a foam substrate can be determined by irradiating one face of the foam substrate with 550 nm wavelength light using the spectrophotometer and measuring the intensity of the light reflected by the foam substrate. The visible light transmittance and the visible light reflectivity of a double-faced PSA sheet can be determined by the same methods as well.

The foam substrate according to an embodiment is colored black or gray. The double-faced PSA sheet comprising a black-colored foam substrate is preferably used for light-blocking purposes. The black color has a lightness (L*) as specified by the L*a*b* color space of preferably 35 or lower (e.g., 0 to 35), or more preferably 30 or lower (e.g., 0 to 30). The gray color has a lightness (L*) as specified by the L*a*b* color space above 35 and below 65. The values of a* and b* as specified by the L*a*b* color space can be suitably selected according to the value of L*. Neither a* nor b* is particularly limited, but it is preferable that each value is in a range of −10 to 10 (more preferably −5 to 5, or even more preferably −2.5 to 2.5). For example, it is preferable that each of a* and b* is zero or near zero.

In the present description, the values of L*, a* and b* as specified by the L*a*b* color space can be determined through measurements with a colorimeter (e.g., colorimeter CR-200 available from Konica Minolta Holdings Inc.). The L*a*b* color space refers to the CIE 1976 (L*a*b*) color space defined by the International Commission on Illumination (CIE) in 1976. In Japanese Industrial Standards, the L*a*b* color space is specified in JIS Z 8729.

Examples of black colorant for coloring the foam substrate include carbon blacks (furnace black, channel black, acetylene black, thermal black, lamp black, etc.), graphite, copper oxide, manganese(IV) oxide, aniline black, perylene black, titanium black, cyanine black, activated carbon, ferrites (non-magnetic ferrite, magnetic ferrite, etc.), magnetite, chromium oxide, iron oxide, molybdenum disulfide, chromium complexes, composite-oxide-based black colorants, anthraquinone-based organic black colorants, and the like. From the standpoint of the cost and the availability, for example, carbon blacks are preferable as the black colorant. The amount of black colorants is not particularly limited, and they can be used in an amount suitable for producing desirable optical properties.

When the double-faced PSA sheet is used for a light reflecting purpose, it is preferable that the foam substrate is colored white. The white color has a lightness (L*) of preferably 87 or higher (e.g., 87 to 100), or more preferably 90 or higher (e.g., 90 to 100). The values of a* and b* as specified by the L*a*b* color space can be suitably selected according to the value of L*. It is preferable that each of a* and b* is in a range of −10 to 10 (more preferably −5 to 5, or even more preferably −2.5 to 2.5). For example, it is preferable that each of a* and b* is zero or near zero.

Examples of a white colorant include inorganic white colorants such as titanium oxides (e.g., titanium dioxides such as rutile titanium dioxide, anatase titanium dioxide, etc.), zinc oxide, aluminum oxide, silicon oxide, zirconium oxide, magnesium oxide, calcium oxide, tin oxide, barium oxide, cesium oxide, yttrium oxide, magnesium carbonate, calcium carbonates (light calcium carbonate, heavy calcium carbonate, etc.), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc oxide, zinc sulfide, talc, silica, alumina, clay, kaolin, titanium phosphate, mica, gypsum, white carbon, diatomaceous earth, bentonite, lithopone, zeolite, sericite, hydrated halloysite, etc.; organic white colorants such as acrylic resin particles, polystyrene-based resin particles, polyurethane-based resin particles, amide-based resin particles, polycarbonate-based resin particles, silicone-based resin particles, urea-formaldehyde-based resin particles, melamine resin particles, etc.; and the like. The amount of white colorants is not particularly limited, and they can be used in an amount suitable for producing desirable optical properties.

The double-faced PSA sheet disclosed herein may further comprise other layer(s) such as an intermediate layer, an undercoat layer, etc., which may be referred to as “optional layer(s)”, besides the foam substrate and the two PSA layers as far as the effects of the present invention are not significantly interfered. For example, the optional layer(s) may be present between the foam substrate and one or each of the two PSA layers. In a double-faced PSA sheet having such a constitution, the thickness of the optional layer(s) is included in the overall thickness of the double-faced PSA sheet (i.e., the thickness from one PSA layer surface to the other PSA layer surface).

The thickness of the foam substrate can be suitably selected in accordance with the strength and flexibility of the double-faced PSA sheet and its purpose of use. In view that the PSA layer can be easily made with a thickness appropriate for desirable adhesive properties, the thickness of the foam substrate is usually suitably 1000 μm or less, preferably 500 μm or less, or more preferably 300 μm or less (e.g. 250 μm or less, typically 200 μm or less). A foam substrate having a thickness of 180 μm or less can be used as well. From the standpoint of the double-faced PSA sheet's impact resistance, repulsion resistance, etc., the thickness of the foam substrate is suitably 30 μm or greater, preferably 50 μm or greater, or more preferably 60 μm or greater (e.g. 80 μm or greater). Here, the repulsion resistance refers to the capability of the double-faced PSA sheet to maintain an elastically deformed shape against its repulsive force to regain the original shape when the double-faced PSA sheet is elastically deformed along the surface structure (possibly a curved surface, a step-having surface, etc.) of an adherend; that is the capability of the double-faced PSA sheet to resist repulsive force.

### <Release Liner>

In the art disclosed herein, a release liner can be used in forming the PSA layer, fabricating the PSA sheet, and storing, distributing and shaping the PSA sheet before used, etc. As the release liner, a suitable species can be selected and used among release liners known or commonly used in the field of double-faced PSA sheets. For instance, in a favorable release liner, the surface of the liner substrate has been subjected to release treatment. As for the liner substrate (subject to release treatment) constituting this type of release liner, a suitable species can be selected and used among various kinds of resin film, paper, cloth, rubber sheet, foam sheet, metal foil, a composite of these (e.g. a layered sheet in which each face of a sheet of paper is laminated with an olefinic resin), etc. The release treatment can be carried out using a known or commonly-used release agent (e.g. a silicone-based, fluorine-based, or long-chain alkyl release agent, etc.) by a typical method. A liner substrate with low adhesiveness formed of a polyolefinic resin (e.g. polyethylene, polypropylene, ethylene-propylene copolymer, polyethylene/polypropylene mixture) or a fluoropolymer (e.g. polytetrafluoroethylene, polyvinylidene fluoride) can be used without release treatment to the liner substrate surface. Alternatively, such a liner substrate with low adhesiveness may be subjected to release treatment and used.

### <Thickness of Double-Faced PSA Sheet>

The double-faced PSA sheet disclosed herein can be usually preferably made in an embodiment where it has an overall thickness of 1500 μm or less. The overall thickness of the double-faced PSA sheet is typically 800 μm or less, preferably 500 μm or less, more preferably 400 μm or less, or yet more preferably 300 μm or less (e.g. 280 μm or less). The double-faced PSA sheet having an overall thickness up to these upper limit values can be advantageous in making products thinner, smaller, lighter, resource-saving, etc. The overall thickness can be typically 50 μm or greater, preferably 100 μm or greater, more preferably 110 μm or greater, or yet more preferably 120 μm or greater (e.g. 130 μm or greater). The double-faced PSA sheet having an overall thickness at or below these lower limit values may exhibit excellent impact resistance and waterproof properties. Here, the overall thickness of the double-faced PSA sheet refers to the thickness from the first adhesive face through the second adhesive face, referring the thickness t from the first adhesive face 11A through the second adhesive face 12A in the example shown in FIG. 1. Thus, for instance, even when the double-faced PSA sheet is in an embodiment where the adhesive faces are protected with a release liner before applied to an adherend, the thickness of the release liner is not included in the thickness of the double-faced PSA sheet referred to here.

### <Applications>

The object (adherend) to which the double-faced PSA sheet disclosed herein is applied is not particularly limited. The double-faced PSA sheet disclosed herein can be applied to adherends formed from, for instance, a metal material such as stainless steel (SUS) and aluminum; an inorganic material such as glass and ceramic; a resin material such as polycarbonate (PC), polymethyl methacrylate (PMMA), polyethylene, polypropylene, polyethylene terephthalate (PET), polybutylene terephthalate (PBT), acrylonitrile-butadiene-styrene copolymer resin (ABS), high impact polystyrene (HIPS), PC-ABS blend resin, PC-HIPS blend resin, and a fluorine resin such as polytetrafluoroethylene (PTFE); a rubber material such as natural rubber and butyl rubber; a composite material of these.

The double-faced PSA sheet disclosed herein is preferably applied to a product which is desired to be cleanable with detergents. In typical, it is preferably used in a portable electronic device which can be touched by hand and carried in various environments and thus are susceptible to contamination such as sticking of oil stains typified by sebum stain, dust, germs, mud, etc. For instance, it is preferably used as a fastening member placed at a location that may come into contact with water when the portable electronic device is washed with water. The double-faced PSA sheet disclosed herein may show excellent resistance even when exposed to various detergents such as body cleansers including body washes, hand washes, shampoos and soaps; kitchen detergents including dishwashing detergents; fabric detergents; and medical detergents. Thus, it can be preferably used for a purpose that allows for cleaning with detergents (typically cleaning with a detergent and water), a purpose in which such cleaning is expected, etc.

The double-faced PSA sheet according to a preferable embodiment comprises a foam substrate and thus may show excellent impact absorption, waterproof properties, sealing properties, etc. With at least a certain level of push-peel strength, even when the PSA sheet is made narrow, the performance degrades little. Thus, it may be favorable as a double-faced PSA sheet used for purposes of bonding, fixing and so on in portable electronics that require narrow pieces. The double-faced PSA sheet disclosed herein can be preferably applied to purposes involving electronics, including, for instance, fixing displays of portable electronics, fixing display-protecting members of portable electronics, fixing key moduli in mobile phones, fixing camera lenses of portable electronics with cameras, fixing decorative TV panels, fixing battery packs of PCs, waterproofing digital camcorder lenses, fixing waterproof breathable membranes and waterproof sound-transmitting membranes in various electronics (e.g. portable electronics). Particularly preferable applications include portable electronic purposes.

The display-protecting member typically has an area optically transparent in the thickness direction, and is called an optically transparent member hereinafter, and may also be called a lens. Here, the concept of lens encompasses both optically refractive and non-refractive species. In other words, the lens as used herein includes non-refractive, optically transparent members, for instance, protective panels that simply protect displays of portable electronics. The protective panel can also be thought as a display-protecting member or display-covering member that is optically transparent. When the material of the protective panel is glass, the protective panel can be called cover glass. It is noted that the material of the protective panel or the lens is not limited to glass and can be any optically transparent material.

As used herein, the portable electronics refer to electronics carried for use in general and are otherwise not particularly limited. Here, being portable means not just providing simple mobility, but further providing a level of portability that allows an individual (average adult) to carry it relatively easily. Examples of the portable electronics referred to herein include smartphones, tablet PCs, notebook PCs, various wearable devices (e.g. wrist wears put on wrists such as wrist watches; modular devices attached to bodies with a clip, strap, etc.; eye wears including glass-shaped wears (monoscopic or stereoscopic, including head-mounted pieces); clothing types worn as, for instance, accessories on shirts, socks, hats/caps, etc.; ear wears such as earphones put on ears; etc.), digital cameras, digital video cameras, acoustic equipment (portable music players, IC recorders, etc.), calculators (e.g. pocket calculators), handheld game devices, electronic dictionaries, electronic notebooks, electronic books, vehicle navigation devices, portable radios, portable TVs, portable printers, portable scanners, and portable modems.

The double-faced PSA sheet disclosed herein can be preferably used for fastening waterproof breathable membranes and waterproof sound-transmitting membranes of electronics (e.g. portable electronics) that comprises acoustic devices. Such electronics, in typical, basically have waterproof properties (preferably properties such that no water invasion is observed in an IPX7 waterproof test). Thus, when further provided with detergent resistance, cleaning with detergents is possible in addition to water washes. Examples of such acoustic devices include speakers, microphones, and buzzers. In a portable electronic device, the double-faced PSA sheet disclosed herein can be applied both to join an acoustic devices to a waterproof breathable membrane or a waterproof sound-transmitting membrane and to join the case of the portable electronic device comprising the acoustic device to the waterproof breathable membrane or the waterproof sound-transmitting membrane. For instance, a waterproof breathable membrane or a waterproof sound-transmitting membrane can be fixed to a case, etc., by applying the double-faced PSA sheet around the membrane periphery, with the PSA sheet being annular (possibly in a frame shape) and comprising the foam substrate. The double-faced PSA sheet utilized in such an embodiments can reduce the loss of acoustic energy. This can eliminate an acoustic gasket. The waterproof breathable membrane or the waterproof sound-transmitting membrane is not particularly limited. They can be porous fluororesin membranes (typically porous PTFE membranes). Alternatively, they can be in a form of laminate film formed of the porous fluororesin membrane and a support layer of nonwoven fabric, etc. Such a porous fluororesin membrane can be obtained by a known or commonly used technique to form pores such as stretching fluororesin film, etc. Accordingly, the present description can provide a laminate comprising an adhering layer formed of the double-faced PSA sheet disclosed herein and a PTFE layer (e.g. a waterproof breathable layer or waterproof sound-transmitting layer formed of a porous PTFE membrane) applied to one adhesive face of the adhering layer. Such a laminate is preferably used in electronics (e.g. portable electronics) for various purposes that require waterproof properties, damp-proof properties, dust-proof properties, sound transmittance and also detergent resistance.

The PSA sheet disclosed herein can be processed into various shapes and preferably used as a bonding member for bonding and fixing components of portable electronics (e.g. bonding a display or a display-protecting member to a case, preferably bonding an optically transparent display-protecting member (typically a protection panel) to a case). In a preferable embodiment, the bonding member has a narrow segment having a width of 30 mm or less and the narrow segment has an average width W of 20 mm or less (more preferably 10 mm or less, yet more preferably 5 mm or less, e g 2 mm or less). Even when used as a bonding member in a shape comprising such a narrow segment (e.g. in a frame shape), the double-faced PSA sheet disclosed herein can provide great performance (push-peel strength, impact absorption, waterproof properties, etc.). The average width W (mm) of the narrow segment in the PSA sheet can be obtained by dividing the total surface area of the narrow segment by the total length of the narrow segment. When the narrow segment has a constant width, the width of the narrow segment is equal to the average width.

The narrow segment is typically linear. Here, the concept of being linear encompasses shapes that are straight, curved, bent (e.g. L-shaped) and also ring-shaped (frame-shaped, circular, etc.) as well as their composite or intermediate shapes. The ring shape is not limited to a curved shape. The concept encompasses, for instance, a ring shape of which part or all is straight, such as a shape that conforms to the circumference of a square (i.e. a frame shape) and a shape that conforms to a sector shape.

Having the advantage of performing well in bonding, providing waterproofness (e.g. waterproofness after being dropped), sealing and so on even with a narrow width, the PSA sheet disclosed herein can be favorably used as a ring-shaped bonding member having the narrow segment, for instance, as a fastening member to bond a display or a display-protecting member in a liquid-tight manner to a case of a portable electronic device so as to protect the electronic device in the case from water and dust. It can be favorably used also as a fastening member to bond a camera lens in a liquid-tight manner to a case of a portable electronic device equipped with a camera function so as to protect the electronic device in the case from water and dust. Thus, the present description provides a fastening member that comprises a PSA sheet disclosed herein and is used for fastening a component (e.g. a display, a display-protecting member, a camera lens) to a case in a portable electronic device. The fastening member is typically ring-shaped in planar view. The annular shape of the ring-shaped fastening member is not particularly limited. It can be, for instance, rectangular (frame-shaped), circular, non-rectangular polygonal (e.g. triangular), or in other irregular shapes. Besides a sheet having a completely closed ring shape (i.e. a seamless ring shape), the concept of ring shape include a shape formed of one sheet or several sheets capable of forming a closed ring when ends are brought to overlap each other and a shape formed of one sheet or several sheets with closely-placed ends so that the closely-placed portions can be sealed as necessary to form a closed ring. Examples of the method for sealing the portions that are overlapped or placed closely (e.g. in contact) include fastening with a sealing material such as adhesives and welding (e.g. thermally welding) the ends.

### EXAMPLES

Several worked examples relating to the present invention are described below, but the present invention is not intended to be limited to these examples. In the description below, “parts” and “%” are based on weight unless otherwise specified. The respective physical properties in the next description were measured or tested in the following ways.

### <Test Methods>

### 1. Degree of Crosslinking of PSA Layer

A measurement sample having a weight W1 was wrapped in a porous PTFE sheet and immersed in ethyl acetate at room temperature for one week. After this, the measurement sample was allowed to dry and the weight W2 of the ethyl acetate-insoluble portion was measured. W1 and W2 were substituted in the next equation to determine the degree of crosslinking (%) of the PSA layer.

Degree of crosslinking (%)=W2/W1×100

As the porous PTFE sheet, was used trade name NITOFLON NTF 1122 available from Nitto Denko Corporation.

### 2. Initial Push-Peel Strength

### (1) Preparation of Test Sample

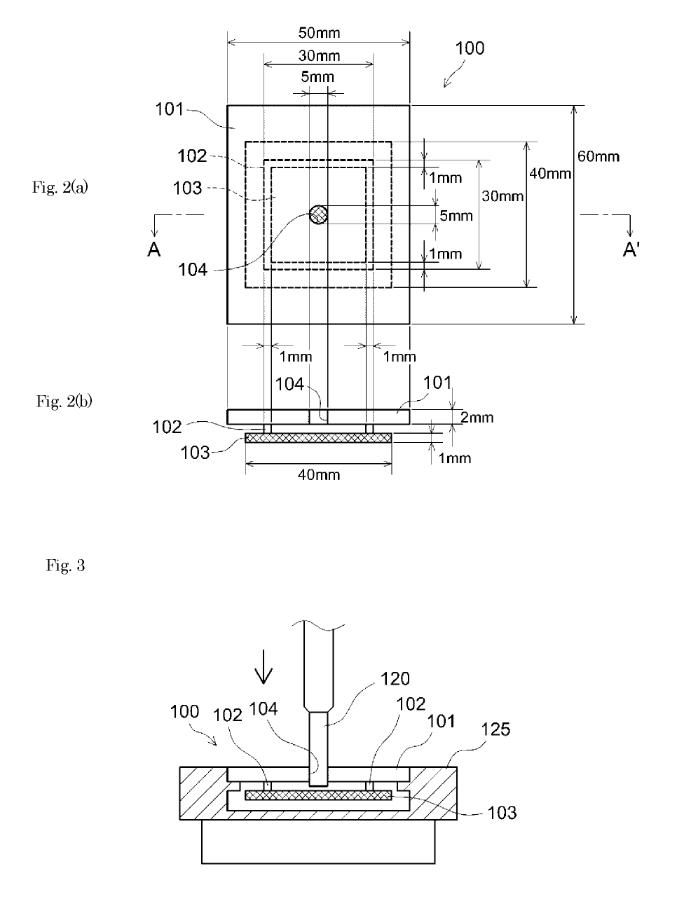

Each double-faced PSA sheet was cut to a window frame shape (frame shape) of 30 mm wide by 30 mm long with 1 mm frame width as shown in FIGS. 2(a) and 2(b) to obtain a window-frame-shaped double-faced PSA sheet 102. Using the window-frame-shaped double-faced PSA sheet 102, a small acrylic plate (acrylic lens) 103 of 40 mm width by 40 mm length by 1 mm thickness was press-bonded under a prescribed load of 5 kg for 10 sec. to a base acrylic plate 101 (PMMA plate of 50 mm width by 60 mm length by 2 mm thickness) having a 5 mm diameter through hole 104 at the center to obtain a test sample 100.

### (2) Measurement of Push-Peel Strength

The push-peel strength of the test sample obtained above was measured by the following method: as shown in FIG. 3, test sample 100 was a laminate of base acrylic plate 101, window-frame-shaped double-faced PSA sheet 102 and small acrylic plate 103; test sample 100 was fastened to a support 125 and set in a universal tensile/compression tester (model name TG-1kN available from Minebea Co., Ltd.); a round rod 120 (4.7 mm diameter) was placed through the through hole 104 in base acrylic plate 101 of test sample 100; round rod 120 was lowered at a rate of 5 mm/min to push the small acrylic plate 103 in the direction away from the base acrylic plate 101; from the maximum stress (N) recorded before base acrylic plate 101 and small acrylic plate 103 separated, the push-peel strength per unit bonding area (cm²) was determined as the initial push-peel strength (N/cm²). The measurement was taken in an environment at 23° C., 50% RH.

It is noted that the load applied by round rod 120 pushing the small acrylic plate 103 caused no warping or breaking of the base acrylic plate 101.

### 3. Push-Peel Strength After Detergent Immersion

### (1) Preparation of Test Sample

A test sample was prepared in the same manner as in the measurement of initial push-peel strength.

### (2) Detergent Immersion Test

A detergent having the composition shown in Table 1 was obtained as the standard detergent. The test sample prepared above was immersed in the standard detergent in a container in an environment at 40° C. for 24 hours. The relative humidity (RH) of the measurement environment was 90% to prevent the detergent from volatizing It is noted that among various detergents (hand washes and dishwashing detergents) studied by the present inventors, trade name KIREI KIREI medicated liquid hand soap available from Lion Corporation caused degradation of adhesive strength; and therefore, this was used as the standard detergent. A PSA sheet that performs well in the test using the standard detergent is expected to produce comparable or greater effects against general commercial detergents.

### (3) Measurement of Push-Peel Strength

After the completion of the detergent immersion test, the test sample was removed from the detergent, washed with room temperature water running at 6.5 L/min for one minute, wiped with dry cloth to remove water droplets, and allowed to dry at 23° C. for one hour. The push-peel strength (N/cm²) after detergent immersion was measured by the same method as for the initial push-peel strength.

TABLE 1

| | |
|---|---|
| | Amount |
| | contained |
| Component | (wt %) |

| | | |
|---|---|---|
| Isopropyl methylphenol | <1 | 17 |
| Laurate | 40 | |
| Myristate | | |
| Monoethanolamine | 2 | |
| Ethylenediaminetetraacetate | <1 | |
| Benzoate | <1 | |
| Glycerin | 43 | |
| Sorbitol | 14 | |
| Polymer | | <1 |
| Water | | 83 |

### 4. Adhesive Strength Retention Rate After Detergent Immersion

With P1 (N/cm²) being the initial push-peel strength and P2 (N/cm²) the push-peel strength after detergent immersion, the adhesive strength retention rate (%) after detergent immersion was determined by substituting P1 and P2 into the next equation.

Adhesive strength retention rate (%)=P2/P1×100.

### 5. Waterproofness

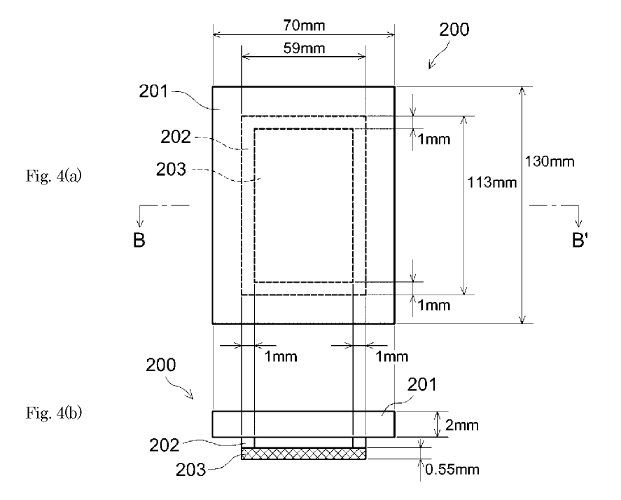

Based on the IPX7 standard (JIS C 0920/IEC60529), the waterproof levels of test samples were evaluated. In particular, each double-faced PSA sheet was cut to a 59 mm wide by 113 mm long window frame shape (frame shape) with 1 mm frame width as shown in FIG. 4(a) and (b) to obtain a window-frame-shaped double-faced PSA sheet 202. Using the window-frame-shaped double-faced PSA sheet 202, a PTFE plate 201 (70 mm wide, 130 mm long, 2 mm thick) was press-bonded under 50 N load for 10 seconds to a glass plate 203 (59 mm wide, 113 mm long, 0.55 mm thick) to obtain a test sample 200.

The test sample was immersed in 1 m deep water in a tank for 30 minutes in the standard condition (23° C., 50% RH) and checked for the presence of internal water invasion.

### Example 1

### (Preparation of Acrylic PSA Composition)

To a reaction vessel equipped with a stirrer, thermometer, nitrogen inlet, condenser and addition funnel, were placed monomers, namely 70 parts of BA, 30 parts of 2EHA, 3 parts of AA and 0.05 part of 4-hydroxybutyl acrylate (4HBA), along with 0.35 part of AIBN as the polymerization initiator and 105 parts of ethyl acetate as the polymerization solvent. The mixture was allowed to undergo solution polymerization at 65° C. under a nitrogen flow for 3.5 hours to obtain a solution of acrylic polymer A.

To the solution of acrylic polymer A, to 100 parts of acrylic polymer A, were added 40 parts of tackifier resins, 3 parts (non-volatile content) of an isocyanate-based crosslinking agent (trade name CORONATE L available from Tosoh Corporation) and 0.03 part (non-volatile content) of an epoxy-based crosslinking agent (trade name TETRAD C available from Mitsubishi Gas Chemical Co., Inc.) to prepare an acrylic PSA composition A.

As for the tackifier resins, were used 10 parts of a rosin ester phenol resin (150° C. softening point), 15 parts of a polymerized rosin ester resin A (120° C. softening point), 10 parts of an disproportionated rosin ester resin (100° C. softening point), and 5 parts of a hydrogenated rosin methyl ester resin (80° C. softening point).

### (Fabrication of Double-Faced PSA Sheet)

The acrylic PSA composition A obtained above was applied with a bar coater to a process release liner, allowed to dry at 110° C. for 3 minutes to form a 25 μm thick PSA layer. The PSA layer was adhered to one surface of a foam substrate to obtain a single-faced PSA sheet. Subsequently, the acrylic PSA composition A was applied to one face of another process release liner of the same kind and allowed to dry at 110° C. for 3 minutes to form a 25 μm thick PSA layer. The resulting PSA layer was adhered to the other face of the foam substrate of the single-faced PSA sheet. After this, one of the process release liners was removed to obtain a double-faced PSA sheet with an overall thickness of 200 μm, layered in the order of release liner/PSA layer/foam substrate/PSA layer.

As the foam substrate, was used a black-colored polyethylene foam substrate with 150 μm thickness, a 3-fold expansion ratio, 108 kPa 25% compressive hardness, 3.18 MPa MD tensile strength, and 5.50 MPa CD tensile strength.

### Example 2

The foam substrate was changed to a foam substrate with a 2.7-fold expansion ratio. Otherwise in the same manner as in Example 1, a double-faced PSA sheet according to this example was fabricated.

### Example 3

The monomer composition was changed to 100 parts of BA, 3 parts of VAc, 5 parts of AA and 0.1 part of 2-hydroxyethyl acrylate (HEA). Toluene was used as the polymerization solvent. Otherwise in the same manner as in Example 1, a solution of acrylic polymer B was obtained.

To the solution of acrylic polymer B, to 100 parts of acrylic polymer B, were added 2 parts (non-volatile content) of an isocyanate-based crosslinking agent (trade name CORONATE L available from Tosoh Corporation) and 0.03 part (non-volatile content) of an epoxy-based crosslinking agent (trade name TETRAD C available from Mitsubishi Gas Chemical Co., Inc.) to prepare an acrylic PSA composition B.

Using the acrylic PSA composition B, but otherwise in the same manner as in Example 2, a double-faced PSA sheet according to this example was fabricated.

### Example 4

In the same manner as in Example 3, a solution of acrylic polymer B was prepared. To the solution of acrylic polymer B, to 100 parts of acrylic polymer B, were added 40 parts of tackifier resins and 2 parts (non-volatile content) of an isocyanate-based crosslinking agent (trade name CORONATE L available from Tosoh Corporation) to prepare an acrylic PSA composition C. As for the tackifier resins, the same species as Example 1 were used in the same amounts. Using the acrylic PSA composition C, but other wise in the same manner as in Example 1, a double-faced PSA sheet according to this example was fabricated.

### Example 5

Into a four-necked flask, were added a monomer mixture formed of 78 parts of 2EHA, 18 parts of N-vinyl-2-pyrrolidone (NVP) and 4 parts of HEA along with photopolymerization initiators, namely, 0.05 part of 2,2-dimethoxy-1,2-diphenylethane-1-one (trade name IRGACURE 651 available from BASF) and 0.05 part of 1-hydroxy-cyclohexyl phenyl ketone (trade name IRGACURE 184 available from BASF). The mixture was irradiated with UV under a nitrogen atmosphere and partially photopolymerized to obtain syrup comprising a partially-polymerized product of the monomer mixture.

To 100 parts of the syrup, were admixed 4 parts of AA as an additional monomer, 0.12 part of 1,6-hexanediol diacrylate (HDDA) as a polyfunctional monomer (crosslinking monomer), and 1 part of black pigment (ATDN 101 BLACK available from Dainichiseika Color & Chemicals Mfg. Co., Ltd.) to prepare an acrylic PSA composition D according to this example.

Two sheets of 38 μm thick PET film were obtained, with each sheet having a release face treated with a silicone-based release agent on one side. To the release face of the first sheet of PET film, the acrylic PSA composition D was applied. The applied PSA composition was covered with the second sheet of PET film and subjected to UV irradiation to cure the PSA composition and form a 250 μm thick PSA layer. The UV irradiation was carried out using a black light (15 W/cm) at a UV ray intensity of 5 mW/cm² (measured with an industrial UV checker (trade name UVR-T1 with light detector model number UD-T36 available from Topcon Technohouse Corporation) with peak sensitivity of 350 nm wavelength) at a light dose of 1500 mJ/cm². A double-faced PSA sheet formed of a PSA layer was thus obtained. The first and second adhesive faces of the PSA sheet were protected with the two sheets of PET film (release liner).

### Example 6

### (Preparation of Rubber-Based PSA Composition)

Were mixed 100 parts of styrene-isoprene block copolymer (SI rubber, product name QUINTAC 3520 available from Zeon Corporation, 15% styrene content, 78% diblock fraction), 30 parts of a terpene resin (115° C. softening point), 40 parts of a terpene phenol resin (145° C. softening point), 40 parts of a petroleum resin (155° C. softening point), 3 parts of antioxidant and toluene as a solvent; the mixture was stirred to prepare a rubber-based PSA composition at 50% NV As the antioxidant, was used product name IRGANOX CB612 available from BASF Corporation (a 2-to-1 (by weight) blend of trade names IRGAFOS 168 and IRGANOX 565 both available from BASF Corporation).

The resulting rubber-based PSA composition was applied with a bar coater to a process release liner and allowed to dry to form a 50 μm thick PSA layer. The PSA layer was adhered to one surface of a foam substrate to obtain a single-faced PSA sheet. Subsequently, the rubber-based PSA composition was applied to one face of another process release liner of the same kind and allowed to dry to form a 50 μm thick PSA layer. The resulting PSA layer was adhered to the other surface of the foam substrate of the single-faced PSA sheet. After this, one of the process release liners was removed to obtain a double-faced PSA sheet with an overall thickness of 250 μm, layered in the order of release liner/PSA layer/foam substrate/PSA layer.

As for the foam substrate, the same kind used in Example 2 was used.

### Example 7

In the same manner as in Example 3, a solution of acrylic polymer B was prepared. To the solution of acrylic polymer B, to 100 parts of acrylic polymer B, were added 40 parts of tackifier resins and 2 parts (non-volatile content) of an isocyanate-based crosslinking agent (trade name CORONATE L available from Tosoh Corporation) to prepare an acrylic PSA composition E.

As for the tackifier resins, were used 10 parts of a polymerized rosin ester resin B (120° C. softening point), 10 parts of a hydrogenated rosin glycerin ester resin (80° C. softening point), 5 parts of a hydrogenated rosin methyl ester resin (80° C. softening point), and 15 parts of a rosin phenol resin (133° C. softening point).

The foam substrate was also changed to a 200 μm thick foam substrate with a 5-fold expansion ratio.

Using the acrylic PSA composition E and the foam substrate, but otherwise in the same manner as in Example 1, a double-faced PSA sheet according to this example was fabricated.

### Example 8

In the same manner as in Example 7, an acrylic PSA composition E was prepared. As for the foam substrate, was obtained the same kind as the one used in Example 1 but with 100 μm thickness. Using the acrylic PSA composition E and the 100 μm thick foam substrate and forming each PSA layer 50 μm thick, but otherwise in the same manner as in Example 1, a double-faced PSA sheet according to this example was fabricated.

### Example 9

In the same manner as in Example 7, an acrylic PSA composition E was prepared. Using the acrylic PSA composition E, but otherwise in the same manner as in Example 2, a double-faced PSA sheet according to this example was fabricated.

### Example 10

In the same manner as in Example 1, a solution of acrylic polymer A was obtained. To the solution of acrylic polymer A, to 100 parts of acrylic polymer A, were added 55 parts of tackifier resins, 3 parts (non-volatile content) of an isocyanate-based crosslinking agent (trade name CORONATE L available from Tosoh Corporation) and 0.03 part (non-volatile content) of an epoxy-based crosslinking agent (trade name TETRAD C available from Mitsubishi Gas Chemical Co., Inc.) to prepare an acrylic PSA composition F.

As for the tackifier resins, were used 10 parts of a rosin ester phenol resin (150° C. softening point), 15 parts of a polymerized rosin ester resin A (120° C. softening point), 10 parts of an disproportionated rosin ester resin (100° C. softening point), 5 parts of a hydrogenated rosin methyl ester resin (80° C. softening point), and 15 parts of a rosin phenol resin (133° C. softening point).

Using the acrylic PSA composition F, but otherwise in the same manner as in Example 1, a double-faced PSA sheet according to this example was fabricated.

### Example 11

The amount of the rosin phenol resin (133° C. softening point) was changed from 15 parts to 7 parts. Otherwise in the same manner as in Example 10, an acrylic PSA composition G was prepared. Using the acrylic PSA composition G, but otherwise in the same manner as in Example 1, a double-faced PSA sheet according to this example was fabricated.

### <Evaluations>

The double-faced PSA sheet according to each example was measured for the degree of crosslinking (%) of the PSA layer, initial push-peel strength (N/cm²), push-peel strength after detergent immersion (N/cm²), adhesive strength retention rate (%) after detergent immersion, and waterproofness. The results are shown in Table 2. Table 2 also summarizes the components of the double-face PSA sheets. The symbol “-” in Table 2 indicates that it was not or could not be measured.

TABLE 2

| | | Ex. 1 | Ex. 2 | Ex. 3 | Ex. 4 | Ex. 5 | Ex. 6 |
|---|---|---|---|---|---|---|---|
| Base polymer | 2EHA | 30 | 30 | | | 78 | SI rubber |
| (monomer | BA | 70 | 70 | 100 | 100 | | |
| composition) | VAc | | | 3 | 3 | | |
| | AA | 3 | 3 | 5 | 5 | 4 | |
| | NVP | | | | | 18 | |
| | 4HBA | 0.05 | 0.05 | | | | |
| | HEA | | | 0.1 | 0.1 | 4 | |
| Tackifier resins | Rosin ester phenol resin | 10 | 10 | | 10 | | |
| (parts*) | Polymerized rosin ester resin A | 15 | 15 | | 15 | | |
| | Polymerized rosin ester resin B | | | | | | |
| | Disproportionated rosin ester | 10 | 10 | | 10 | | |
| | Hydrogenated rosin glycerin ester resin | | | | | | |
| | Hydrogenated rosin methyl ester resin | 5 | 5 | | 5 | | |
| | Rosin phenol resin | | | | | | |
| | Terpene resin | | | | | | 30 |
| | Terpene phenol resin | | | | | | 30 |
| | Petroleum resin | | | | | | 40 |
| | Total | 40 | 40 | 0 | 40 | 0 | 100 |
| Crosslinking | Isocyanate-based | 3 | 3 | 2 | 2 | | |
| agent (parts)* | Epoxy-based | 0.03 | 0.03 | 0.03 | | | |
| | HDDA | | | | | 0.12 | |
| Degree of crosslinking (%) of PSA layer | | 35 | 35 | 52 | 18 | 68 | — |
| Substrate | Species | PE foam | PE foam | PE foam | PE foam | None | PE foam |
| | Expansion ratio (fold) | 3 | 2.7 | 2.7 | 3 | — | 2.7 |
| | Thickness (μm) | 150 | 150 | 150 | 150 | — | 150 |

| | | | | | | |
|---|---|---|---|---|---|---|
| Overall thickness (μm) | 200 | 200 | 200 | 200 | 250 | 250 |
| Initial push-peel strength (N/cm²) | 84 | 62 | 57 | 84 | 85 | 90 |
| Push-peel strength (N/cm²) after detergent immersion | 70 | 51 | 35 | 48 | 44 | 81 |
| Adhesive strength retention rate (%) | 83 | 82 | 62 | 57 | 52 | 90 |
| Waterproofness | Good | Good | Good | Good | Good | Good |

| | | Ex. 7 | Ex. 8 | Ex. 9 | Ex. 10 | Ex. 11 |
|---|---|---|---|---|---|---|
| Base polymer | 2EHA | | | | 30 | 30 |
| (monomer | BA | 100 | 100 | 100 | 70 | 70 |
| composition) | VAc | 3 | 3 | 3 | | |
| | AA | 5 | 5 | 5 | 3 | 3 |
| | NVP | | | | | |
| | 4HBA | | | | 0.05 | 0.05 |
| | HEA | 0.1 | 0.1 | 0.1 | | |
| Tackifier resins | Rosin ester phenol resin | | | | 10 | 10 |
| (parts*) | Polymerized rosin ester resin A | | | | 15 | 15 |
| | Polymerized rosin ester resin B | 10 | 10 | 10 | | |
| | Disproportionated rosin ester | | | | 10 | 10 |
| | Hydrogenated rosin glycerin ester resin | 10 | 10 | 10 | | |
| | Hydrogenated rosin methyl ester resin | 5 | 5 | 5 | 5 | 5 |
| | Rosin phenol resin | 15 | 15 | 15 | 15 | 7 |
| | Terpene resin | | | | | |
| | Terpene phenol resin | | | | | |
| | Petroleum resin | | | | | |
| | Total | 40 | 40 | 40 | 55 | 47 |
| Crosslinking | Isocyanate-based | 2 | 2 | 2 | 3 | 3 |
| agent (parts)* | Epoxy-based | | | | 0.03 | 0.03 |
| | HDDA | | | | | |
| Degree of crosslinking (%) of PSA layer | | 25 | 25 | 34 | 28 | 34 |
| Substrate | Species | PE foam | PE foam | PE foam | PE foam | PE foam |
| | Expansion ratio (fold) | 5 | 3 | 2.7 | 3 | 3 |
| | Thickness (μm) | 200 | 100 | 150 | 150 | 150 |

| | | | | | |
|---|---|---|---|---|---|
| Overall thickness (μm) | 250 | 200 | 200 | 200 | 200 |
| Initial push-peel strength (N/cm²) | 49 | 42 | 60 | 94 | 89 |
| Push-peel strength (N/cm²) after detergent immersion | 24 | 20 | 29 | 43 | 38 |
| Adhesive strength retention rate (%) | 48 | 48 | 49 | 46 | 43 |
| Waterproofness | Good | Good | Good | Good | Good |

*to 100 parts of base polymer

As shown in Table 2, with respect to Examples 1 to 6, the push-peel strength after detergent immersion was at least 30 N/cm² with 50% or higher adhesive strength retention rates after detergent immersion. This shows that the double-faced PSA sheets according to these examples have high detergent resistance. On the other hand, the adhesive strength significantly decreased after the detergent cleaning with respect to the double-faced PSA sheets according to Examples 7 to 11 with less than 30 N/cm² of push-peel strength after detergent immersion or less than 50% of adhesive strength retention rate after detergent immersion. Thus, if products using these double-faced PSA sheets are cleaned with detergents, degradation of the adhesive properties such as adhesive strength may cause deterioration and failure in these products.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1 double-faced PSA sheet
11 first PSA layer
11A first adhesive face
12 second PSA layer
12A second adhesive face
15 substrate
15A first surface
15B second surface
17 release liner
17A front face of release liner
17B back face of release liner

What is claimed is:

1. An adhesively double-faced pressure-sensitive adhesive sheet comprising a pressure-sensitive adhesive layer,
exhibiting a push-peel strength of 30 N/cm² or greater after a detergent immersion test involving immersion in a standard detergent at 40° C. for 24 hours, and
having an adhesive strength retention rate of 50% or higher, determined as the ratio of push-peel strength P2 after the detergent immersion test to push-peel strength P1 before the detergent immersion test.

2. The double-faced pressure-sensitive adhesive sheet according to claim 1, wherein the pressure-sensitive adhesive layer is an acrylic pressure-sensitive adhesive layer comprising an acrylic polymer as its base polymer.

3. The double-faced pressure-sensitive adhesive sheet according to claim 2, wherein the acrylic polymer is crosslinked with at least one species of crosslinking agent selected from the group consisting of isocyanate crosslinking agents and epoxy-based crosslinking agents.

4. The double-faced pressure-sensitive adhesive sheet according to claim 2, wherein the pressure-sensitive adhesive layer comprises at least one species of tackifier resin selected from the group consisting of a rosin-based tackifier resin, a terpene-based tackifier resin, a phenolic tackifier resin and a petroleum resin.

5. The double-faced pressure-sensitive adhesive sheet according to claim 4, wherein the tackifier resin content in the pressure-sensitive adhesive layer is 20 parts to 45 parts by weight to 100 parts by weight of the acrylic polymer.

6. The double-faced pressure-sensitive adhesive sheet according to claim 1, wherein the pressure-sensitive adhesive layer has a degree of crosslinking of 30% or higher.

7. The double-faced pressure-sensitive adhesive sheet according to claim 1, comprising a foam substrate and having the pressure-sensitive adhesive layer on each face of the foam substrate.

8. The double-faced pressure-sensitive adhesive sheet according to claim 1, consisting of the pressure-sensitive adhesive layer.

9. A laminate comprising an adhering layer formed of the double-faced pressure-sensitive adhesive sheet according to claim 1 and a fluororesin layer applied to one adhesive face of the adhering layer.

10. The double-faced pressure-sensitive adhesive sheet according to claim 1 used for bonding components of a portable electronic device.
